(19) United States
(12) Patent Application Publication
(10) Pub. No.: US 2015/0068923 A1
(43) Pub. Date: Mar. 12, 2015

(54) BIOSENSOR MONITORS, TEST STRIPS AND ACTIVATION MECHANISMS AND METHODS THEREOF

(71) Applicant: Joinsoon Medical Technology Co., Ltd., New Taipei (TW)

(72) Inventors: JEN-FANG LEE, New Taipei (TW); KUAN-CHIH HUANG, New Taipei (TW)

(21) Appl. No.: 14/482,110

(22) Filed: Sep. 10, 2014

Related U.S. Application Data
(60) Provisional application No. 61/877,202, filed on Sep. 12, 2013.

(51) Int. Cl. G01N 27/327

(52) U.S. Cl. CPC G01N 27/3274; G01N 27/3272; G01N 27/3273
USPC 205/782; 204/401

(57) ABSTRACT

The disclosure is directed to biosensor monitors, test strips and activation mechanisms and methods thereof. The biosensor monitor is for verifying a test strip to be used with the biosensor monitor. The monitor includes verification components located within the monitor and accessible to a test strip to be inserted into the biosensor monitor. The verification components interact with verification portions of the test strip to allow the biosensor monitor to verify the test strip before the biosensor monitor tests biological material on the test strip. A test strip and methods are also described.

### CROSS-REFERENCE TO RELATED APPLICATION

This application claims the benefit of U.S. Provisional Application No. 61/877,202, filed Sep. 12, 2013, the contents of which are incorporated herein by reference.

### FIELD

Aspects of the present disclosure relate generally to the field of biosensor monitors, test strips and activation mechanisms and Methods thereof, and more particularly to an activation mechanism for a biosensor monitor to verify the identity of a test strip and to activate the biosensor monitor accordingly.

### BACKGROUND

A patient's blood glucose level may be measured by placing a small drop of blood sample onto a test strip. Then, the test strip is inserted into a glucose meter, which will detect the presence of blood glucose. If blood glucose is detected, the glucose meter will be turned on to measure the blood glucose level.

Although easy to implement, this activation mechanism may not fit the needs of many modern manufacturers. First, this activation mechanism cannot prevent users from using a non-conforming test strip with a glucose meter. Using non-conforming test strips may damage the glucose meter, and may result in inaccurate readings. A non-conforming test strip may be made by a counterfeiter or a competitor. Additionally, this activation mechanism does not allow a biosensor monitor 100 to distinguish one type of test strip from another. For exemplary, a manufacturer may have one type of test strip for home tests, and another type of test strip for professional uses. Therefore, to prevent test strips produced by the same manufacture from being used on wrong glucose meter, it is important to have test strips specifically compatible with a specific glucose meter.

Accordingly, there is a need for an activation mechanism for a biosensor monitor 100 to verify the identity of the inserted test strip, and to activate the biosensor monitor 100 accordingly.

### BRIEF DESCRIPTION OF THE DRAWINGS

FIG. 1 is a biosensor monitor and test strip according to an exemplary embodiment.

FIG. 2 is a diagrammatic view of an exemplary embodiment of a biosensor monitor according to FIG. 1.

FIG. 3 is a generic method for detecting the identity of the test strip according to an exemplary embodiment.

FIGS. 4A-4B are illustrative views of additional exemplary test strips.

FIGS. 5A-5B are illustrative views of additional exemplary test strips.

FIGS. 6A-6D are illustrative views of additional exemplary test strips.

FIGS. 7-10 illustrate exemplary activation methods of a biosensor monitor.

FIGS. 11-18 are illustrative views of exemplary test strips.

FIGS. 19-20 are illustrative views of exemplary test strips.

FIGS. 21-24 illustrate exemplary second portions of the test strip.

FIG. 25 is an illustrative view of an exemplary test strip.

FIGS. 26-29 illustrate exemplary embodiments of the second portion of the test strip.

FIGS. 30-37 are illustrative views of exemplary embodiments of the test strip and the biosensor monitor.

FIGS. 38-46 are illustrative views of exemplary embodiments of the test strip and the biosensor monitor.

FIGS. 47-49 are illustrative views of exemplary embodiments of the test strip and the biosensor monitor.

FIG. 50 illustrates exemplary activation method of a biosensor monitor.

FIGS. 51-52 are illustrative views of exemplary embodiments of the test strip and the biosensor monitor.

FIGS. 53-54 are illustrative views of exemplary embodiments of the test strip and the biosensor monitor.

FIG. 55 illustrates exemplary activation method of a biosensor monitor.

FIGS. 56-58 are illustrative views of exemplary embodiments of the test strip and the biosensor monitor.

FIG. 59 illustrates exemplary activation method of a biosensor monitor.

FIG. 60 is an illustrative views of exemplary embodiment of the test strip and the biosensor monitor.

FIG. 61 illustrates exemplary activation method of a biosensor monitor.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series and the like.

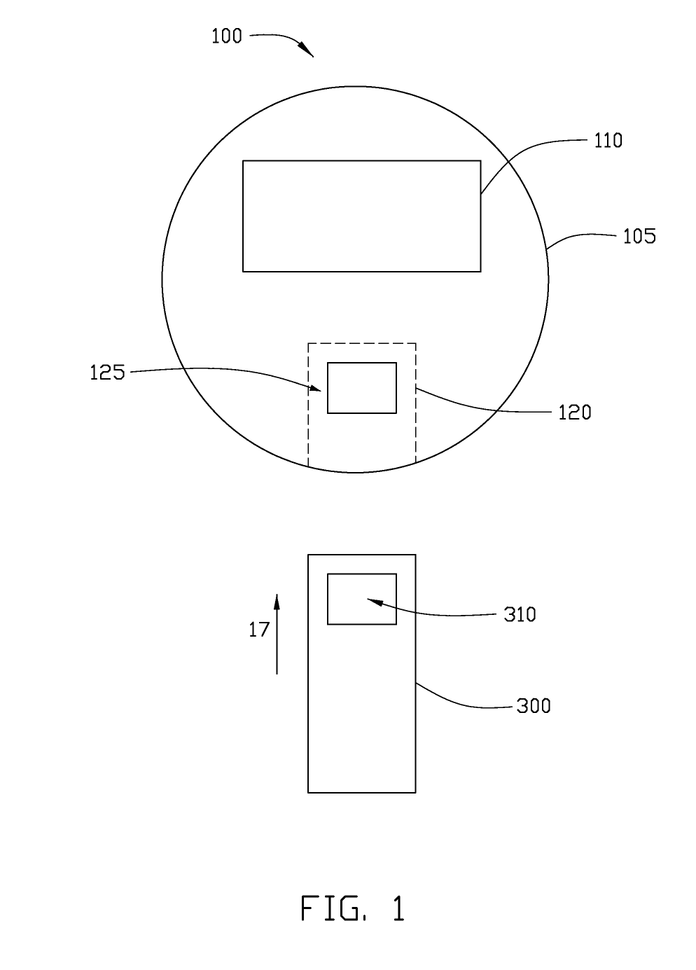

FIG. 1 is a biosensor monitor 100 and a test strip 300 according to an exemplary embodiment. Exemplary biosensor monitor 100 allows the biosensor monitor 100 to verify the source and type of the inserted test strip 300. If the source and type of the test strip 300 are acceptable, the biosensor monitor 100 may be activated to analyze or test the blood. The exemplary activation mechanisms and methods allow a biosensor 100 to distinguish among different types of test strips 300. With this activation mechanism, a biosensor monitor 100 provided by a supplier can be activated only when used with a test strip configured to conform to the specific glucose meter. Any other test strip not properly configured will be unable to turn on the biosensor monitor 100.

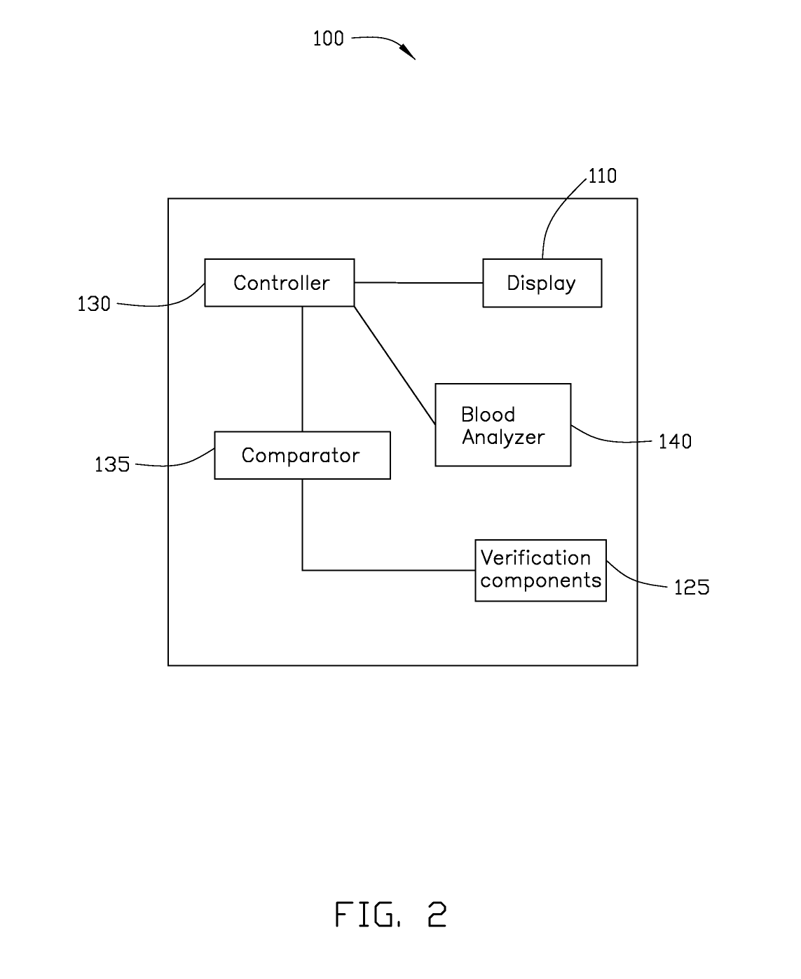

In more detail, biosensor monitor 100 comprises a body 105 for containing circuitry (see FIG. 2) associated with the biosensor monitor 100, a display 110, and a test strip receiving hole or slot 120. Within test strip receiving hole 120 is/are one or more verification components 125. As used herein and in the claims, the term “verification components” means the various features described herein and used to interact with the verification portion features of the test strip. Verification components 125 can comprise features, such as, but not limited to: conductive pins, light sensors and detectors, color detectors, bar code detectors, signal receivers, and sensor modules for interacting with the verification portions of the test strip, as described below. Accordingly, in FIG. 1, verification component 125 is shown as a generic “black box” structure.

Test strip 300 is shown in FIG. 1 as for being inserted into receiving hole 120 of the biosensor monitor 100 in insertion direction 17. Test strip 300 includes a verification portion 310. As used herein and in the claims, the term “verification portion” means the various test features provided on the test strip, such as, but not limited to: conductive pads, reflective pads, light through holes, barcodes, color patterns of different colored or different shaped printed blocks, and a signal transmitter that are for interacting with the verification component 125 of the biosensor monitor 100. Accordingly, in FIG. 1, verification portions 310 are shown as a generic “black box” structure.

FIG. 2 is a diagrammatic view of an exemplary biosensor monitor 100. Biosensor monitor 100 includes display 110, verification components 125, controller 130, comparator 135, and a blood analyzer 140. In its most generic form and operation, comparator 135 determines whether verification portion 125 detect the appropriate verification portions 310 of test strip 300. Depending upon that comparison, controller 130 sends a message to display 110 and a signal for activating or not activating the blood analyzer 140 within biosensor 100. This generic form and operation is explained in much more detail below.

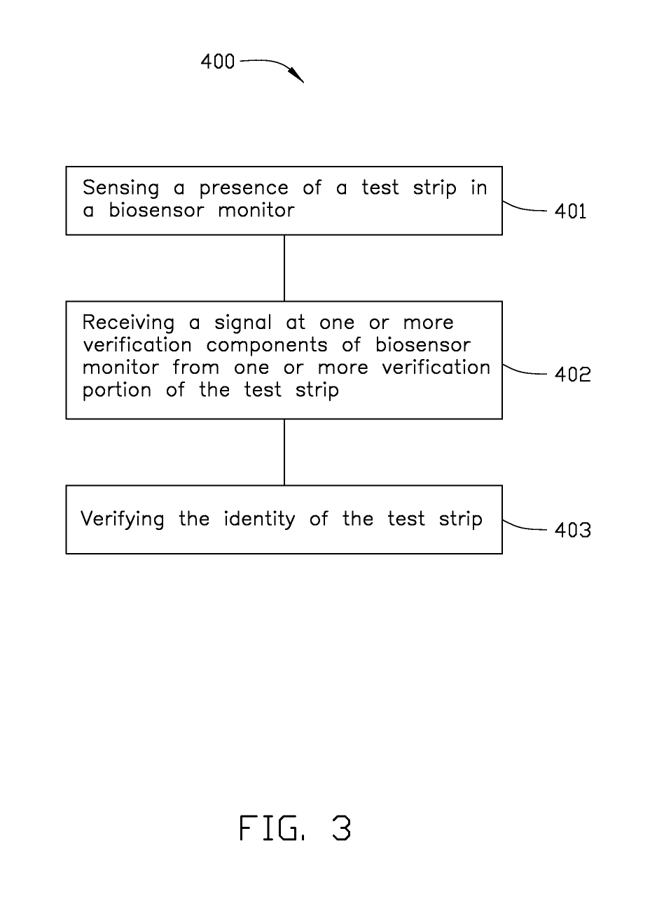

FIG. 3 is a generic method for detecting the identity of the test strip according to an exemplary embodiment.

In its most generic and simplified form and as shown in FIG. 3, the method 400 includes sensing a presence of a test strip in a biosensor monitor, in step 401; receiving a signal at one or more verification components of the biosensor monitor from one or more verification portions of the test strip, in step 402; and verifying the identity of the test strip, in step 403.

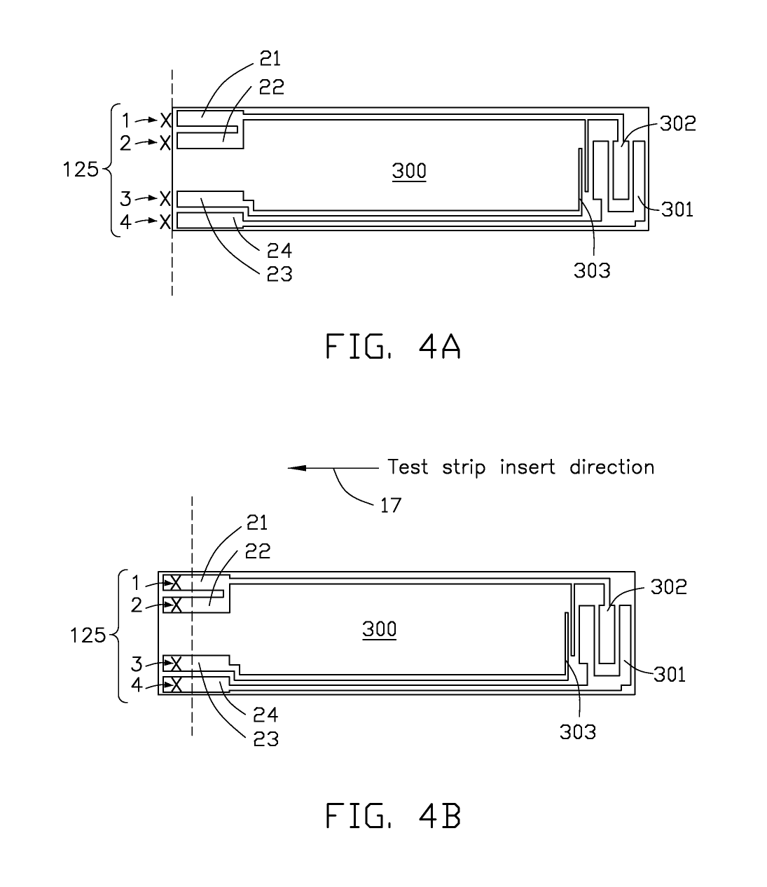

FIGS. 4A-4B are illustrative views of exemplary test strips. In these exemplary embodiments the verification portion 310 of the test strip 300 can be conductive pads 21, 22, 23, and 24 that allow the biosensor monitor 100 to determine whether the test strip 300 has been inserted into the biosensor monitor 100. For exemplary, in FIG. 4A, the verification components 125 of the biosensor monitor 100 can be contact pins 1, 2, 3 and 4. For clarity, the housing of the biosensor monitor 100 and the structure of the contact pins have been omitted.

According to this first exemplary embodiment, in FIG. 4A, before the test strip 300 is inserted into the biosensor monitor 100 in direction 17, the contact pins 1, 2, 3, and 4 are not electrically connected to each other. This allows the biosensor monitor 100 to know the test strip 300 is not inserted therein.

In FIG. 4B, when the test strip 300 is inserted into the biosensor monitor 100, the pins 1, 2, 3 and 4 may be in contact with the conductive pads 21, 22, 23, and 24 respectively. The conductive pad 21 electrically connects to conductive pad 22 and further connects to the electrode 302, which may either be a working or reference electrode. The conductive pad 24 electrically connects to the electrode 301. The electrodes 301 and 302 form a pair of working and reference electrodes, forming a reaction zone. As shown in FIG. 4A and FIG. 4B, because the conductive pads 21 and 22 are electrically connected to each other, after the insertion of the test strip 300 into the biosensor monitor 100, the pins 1 and 2 are electrically connected to each other within the biosensor monitor 100. When comparator circuit 135 and conventional controller 130 within the biosensor monitor 100 detect the electrical connection between the pins 1 and 2, the biosensor monitor 100 knows if a test strip 300 has been inserted into the biosensor monitor 100.

After the detected insertion of the test strip 300, the biosensor monitor 100 may be activated, for exemplary, waking up from the sleep mode, e.g., the biosensor monitor 100 may now turn on a display, or brighten part of the display. Additionally, the blood analyzer 140 will analyze the blood sample. The biosensor monitor 100 may also display a symbol indicating that a test strip has been inserted. To attract a user's attention, the symbol may be text with a different font or size, or may be a flashing graph or text.

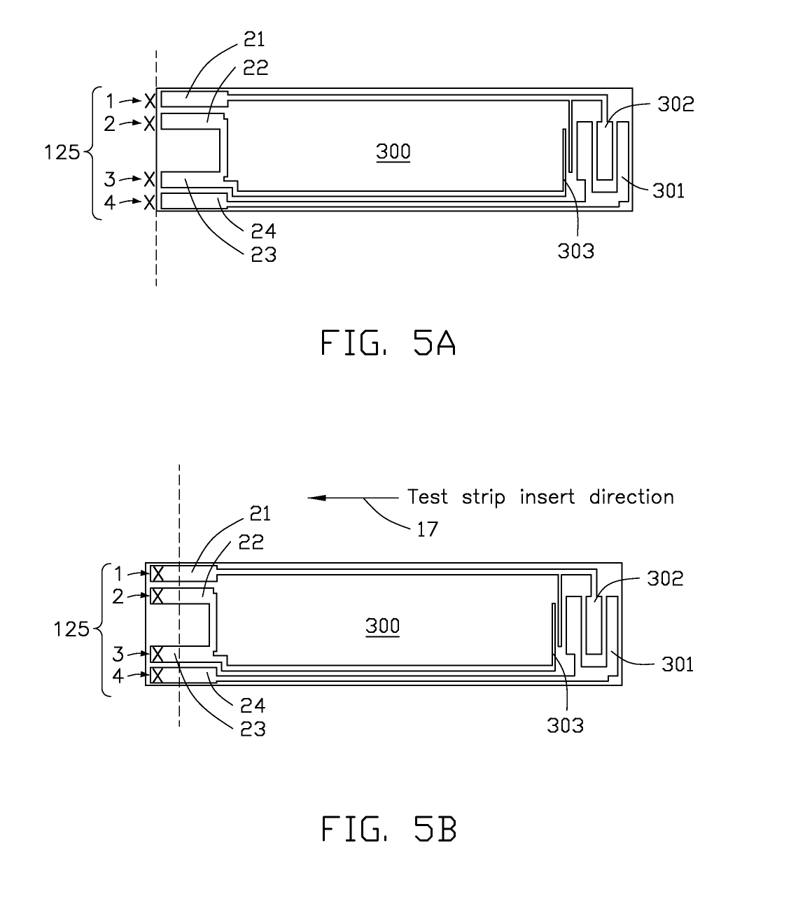

In FIGS. 4A, 4B, although the conductive pads 21 and 22 are both connected to the electrode 302, the principle disclosure is not so limited. For exemplary, as illustrated in the exemplary embodiment of FIG. 5A, 5B, the conductive pads 22 and 23 may be connected to each other and the electrode 303. Thus, the biosensor monitor 100 may determine whether a test strip 300 has been inserted by checking the electrical connection between the pins 2 and 3.

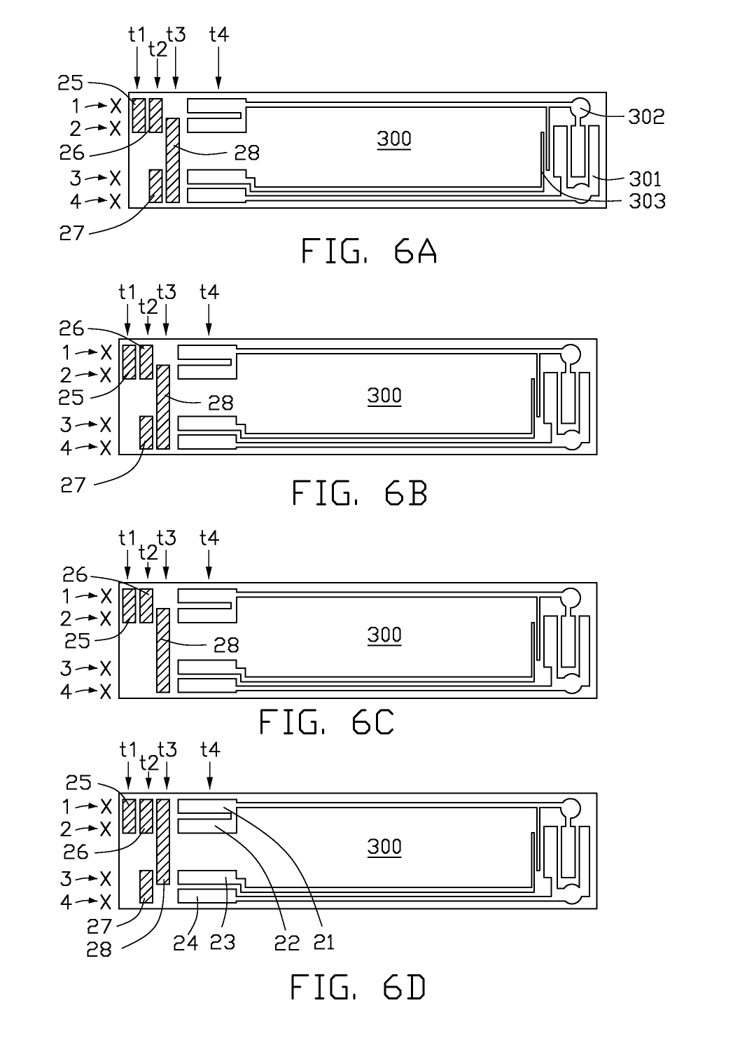

In FIG. 6A-6D, according to another exemplary embodiment, additional conductive pads located on the test strip 300 can provide source information for test strip 300. For exemplary, in FIG. 6A, when the test strip 300 is being inserted into the biosensor monitor 100, at time t1, the pins 1 and 2 may be in contact with a conductive pad 25 and therefore pins 1 and 2 may be electrically connected. The biosensor monitor 100 may detect such electrical connection and compare it against a first predetermined condition, for exemplary, whether there exists an electrical connection between the pins 1 and 2. If the electrical connection does not satisfy the first predetermined condition, the biosensor monitor 100 may reject the test strip 300 by displaying an error message. Otherwise, the biosensor monitor 100 may proceed with the activation process.

In FIG. 6B, at time t2, the pins 1 and 2 may be in contact with a conductive pad 26, and the pins 3 and 4 may be in contact with a conductive pad 27. Therefore, the pins 1 and 2 may be electrically connected, and the pins 3 and 4 may be electrically connected. The biosensor monitor 100 may detect such electrical connections and compare them against a second predetermined condition, for exemplary, whether there exist electrical connections between the pins 1 and 2, and between the pins 3 and 4. If the electrical connections do not satisfy the second predetermined condition, the biosensor monitor 100 may again reject the test strip 300 by displaying an error message. Otherwise the biosensor monitor 100 may further proceed with the activation process.

In FIG. 6C, at time t3, the pins 2, 3 and 4 may be in contact with a conductive pad 28. Therefore, the pins 2, 3 and 4 are electrically connected. The biosensor monitor 100 may detect such electrical connection and compare it with a third predetermined condition, for exemplary, whether there exists an electrical connection between the pins 2 and 3, or between the pins 3 and 4, or between the pins 2 and 4. If the electrical connection does not satisfy the third predetermined condition, the biosensor monitor 100 may again reject the test strip 300 by displaying an error message. Otherwise, the biosensor monitor 100 may further proceed with the activation process.

In FIG. 6D, at time t4, the pins 1, 2, 3 and 4 may be in contact with the conductive pads 21, 22, 23 and 24, respectively. The conductive pads 21 and 22 may be connected to the electrode 302. The conductive pad 23 may be connected to the electrode 303. The conductive pad 24 may be connected to the electrode 301. The electrodes 301, 302 and 303 may be used to measure the voltage or current across the reaction region (defined above). If the first, second and third predetermined conditions have all been satisfied, the source of the test strip 300 has been verified, and the biosensor monitor 100 may wake up from the sleep mode or power saving mode.

Furthermore, FIGS. 6A-6C show the pins 1 and 2 are electrically connected at time t1, the pins 3 and 4 are electrically connected at time t2, and the pins 2, 3 and 4 are electrically connected at time t3. If such connections satisfy all predetermined conditions, the source of the test strip 300 may be verified.

Instead of sequentially detecting the electrical connections among the pins, according to some exemplary embodiments, the biosensor monitor 100 may sequentially detect the electric resistance values among them. For exemplary, in FIG. 6A, at time t1, when the test strip 300 is being inserted into the biosensor monitor 100, the pins 1 and 2 may be in contact with a conductive pad 25, and so the pins 1 and 2 may be electrically connected. The biosensor monitor 100 may then check whether the electric resistance value between the pins 1 and 2 conforms to a first predetermined value. If not, the biosensor monitor 100 may reject the test strip 300 by displaying an error message. Otherwise, the biosensor monitor 100 may proceed with the activation mechanism to perform further checks at time t2 and time t3. If the electric resistance values of the pins at time t1, t2, and t3 all conform to the predetermined values, the source of the test strip 300 may be considered verified.

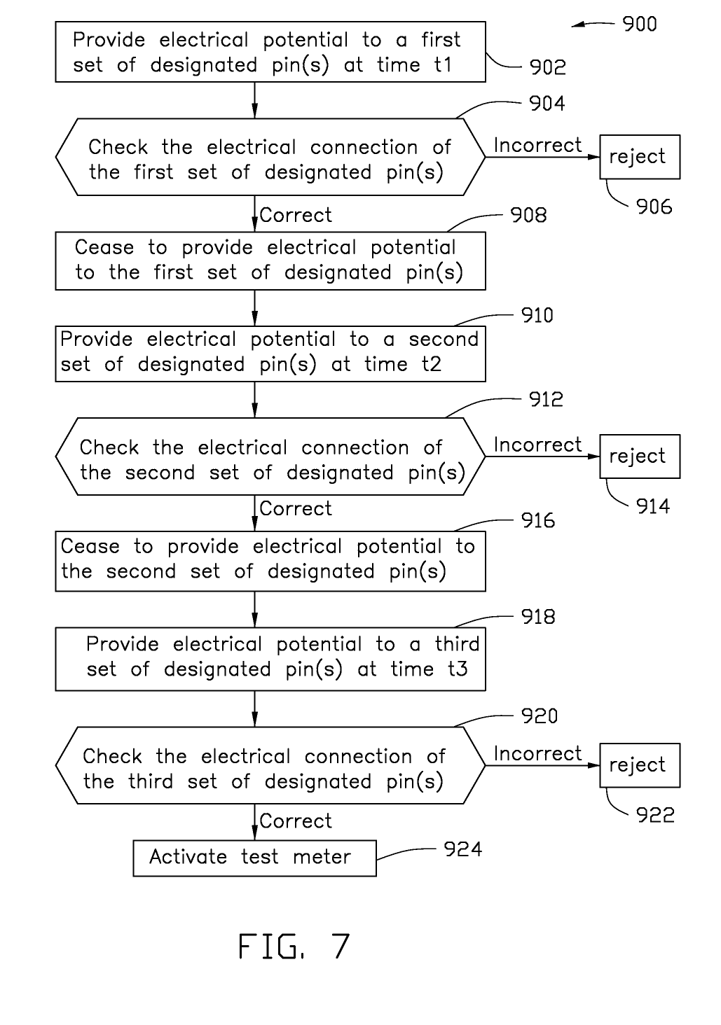

FIGS. 7-10 illustrate exemplary activation methods for a biosensor monitor 100. As previously described, the method may sequentially detect the electrical connections or the electric resistance values among its pins. Once the entire detection sequence is completed, the biosensor monitor 100 may reject the nonconforming test strip 300 or accept a conforming test strip 300. Alternatively, the biosensor monitor 100 may accept the conforming strip 300 or reject a test strip 300 immediately if any the sensed value or connection at that time is deemed unacceptable.

In FIG. 7, an exemplary verification method 900 with active electrical potential provision is provided. This method is implemented by the biosensor monitor 100 actively changing the electrical potential provided to the pins. With reference to FIG. 7, at time t1, the biosensor monitor 100 provides electrical potential to the first combination of pins, i.e., the pins 1 and 2, in step 902. When pins 1 and 2 are in contact with a conductive pad 25, the biosensor monitor 100 may detect the electrical connection. Next, the biosensor monitor 100 via the comparator 135 may compare such electrical connection with a first predetermined condition, for exemplary, whether there exists an electrical connection between pins 1 and 2, in step 904. If the first predetermined condition is not fulfilled, the test strip 300 may be rejected and the biosensor monitor 100 may not be activated, as illustrated in step 906. An error message may then be displayed on the screen of the biosensor monitor 100.

On the other hand, if the first predetermined condition is fulfilled, the biosensor monitor 100 ceases to provide electrical potential to the first combination of the pins 1 and 2 in step 908. Next, the biosensor monitor 100 may provide electrical potential to the second combination of pins, i.e., the pins 3 and 4, at time t2 in step 910. When pins 3 and 4 are in contact with a conductive pad 27, the biosensor monitor 100 may detect the electrical connection therebetween. Thereafter, the biosensor monitor 100 may compare such electrical connection with a second predetermined condition, for exemplary, whether there exists an electrical connection between pins 3 and 4, in step 912. If the second predetermined condition is not fulfilled, the test strip 300 may be rejected and the biosensor monitor 100 may not be activated, as illustrated in step 914. An error message may be displayed on the screen of the biosensor monitor 100. On the other hand, if the second predetermined condition is fulfilled, the biosensor monitor 100 ceases to provide electrical potential to the second combination of the pins 3 and 4 in step 916. Next, the biosensor monitor 100 may provide electrical potential to the third combination of pins, i.e., the pins 2, 3 and 4, at time t3 in step 918. When pins 2 and 3, or 3 and 4, or 2 and 4 are in contact with a conductive pad 28, the biosensor monitor 100 may detect the electrical connection between them. Next, the biosensor monitor 100 may compare such electrical connection with a third predetermined condition, for exemplary, whether there exists an electrical connection between pins 2 and 3, or 3 and 4, or 2 and 4, in step 920. If the third predetermined condition is not fulfilled, the test strip 300 may be rejected and the biosensor monitor 100 may not be activated, as illustrated in step 922. An error message may be displayed on the screen of the biosensor monitor 100. On the other hand, if the third predetermined condition is fulfilled, at time t4, the biosensor monitor 100 may be activated from the sleep mode or the power saving mode in step 924. As a result, the biosensor monitor 100 may serve to measure the voltage or current across the electrodes 301, 302 and 303 when the blood sample is mixed or reacted with the reaction enzyme or reaction reagent. The sequential fulfillments of the first, second and third predetermined conditions represent that the source of the test strip 300 inserted is correct. Therefore, a verification method with active electrical potential provision is provided.

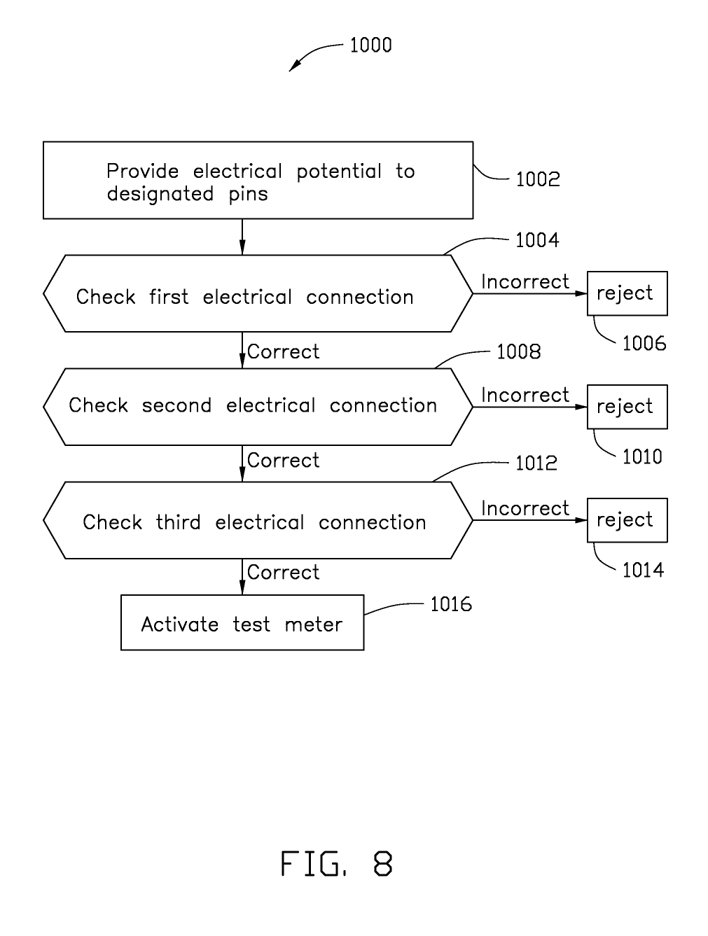

In FIG. 8, an exemplary verification method 1000 with passive electrical potential provision is provided. In other words, the method in this embodiment is implemented by the biosensor monitor 100 providing unchanged electrical potential to the pins respectively. In detail, with reference to FIG. 8, when the biosensor monitor 100 is in the sleep mode or the power saving mode, the biosensor monitor 100 may provide electrical potential to designated pins in step 1002. In particular, the voltage at pin 2 is lower than that at pin 1, the voltage at pin 3 is lower than that at pin 2, and the voltage at pin 4 is lower than that at pin 3. For exemplary, the voltage may be 10V at pin 1, 7V at pin 2, 3V at pin 3, and zero (grounded) at pin 4. In step 1004, when the pins 1 and 2 are in contact with one electrode, the biosensor monitor 100 may detect an electric current flowing from pin 1 to pin 2, i.e., an electrical connection.

Accordingly, the biosensor monitor 100 may compare such with a first predetermined condition, for exemplary, whether there exists an electrical connection between pins 1 and 2 in step 1004. If the first predetermined condition is not fulfilled, the test strip 300 may be rejected and the biosensor monitor 100 may not be activated, as illustrated in step 1006. On the other hand, if the first predetermined condition is fulfilled, the biosensor monitor 100 may proceed with the activation method. In step 1008, when the pins 3 and 4 are in contact with one electrode, the biosensor monitor 100 may detect an electric current flowing from pin 3 to pin 4, i.e., an electrical connection. Accordingly, the biosensor monitor 100 may compare such with a second predetermined condition, for exemplary, whether there exists an electrical connection between pins 3 and 4 in step 1008. If the second predetermined condition is not fulfilled, the test strip 300 may be rejected and the biosensor monitor 100 may not be activated, as illustrated in step 1010. On the other hand, if the second predetermined condition is fulfilled, the biosensor monitor 100 may proceed with the activation method. In step 1012, when the pins 2, 3 and 4 are in contact with a conductive pad 28 and therefore are electrically connected, the biosensor monitor 100 may detect an electric current flowing from pin 2 to pin 3, from pin 3 to pin 4, or from pin 2 to pin 4. That is, an electrical connection between pins 2 and 3, or 3 and 4, or 2 and 4 may be established. Accordingly, the biosensor monitor 100 may compare such with a third predetermined condition, for exemplary, whether there exists an electrical connection between pins 2 and 3, or 3 and 4, or 2 and 4 in step 1012. If the third condition is not fulfilled, the test strip 300 may be rejected and the biosensor monitor 100 may not be activated, as illustrated in step 1014. On the other hand, if the third condition is fulfilled, at time t4 the biosensor monitor 100 may be activated from the sleep mode or the power saving mode in step 1016 and may serve to measure the voltage or current across the electrodes 301, 302 and 303 when the blood sample is mixed or reacted with the reaction enzyme or reaction reagent. The sequential fulfillments of the first, second and third predetermined conditions represent that the source of the test strip 300 inserted is correct. Therefore, a verification method with passive electrical potential provision is provided.

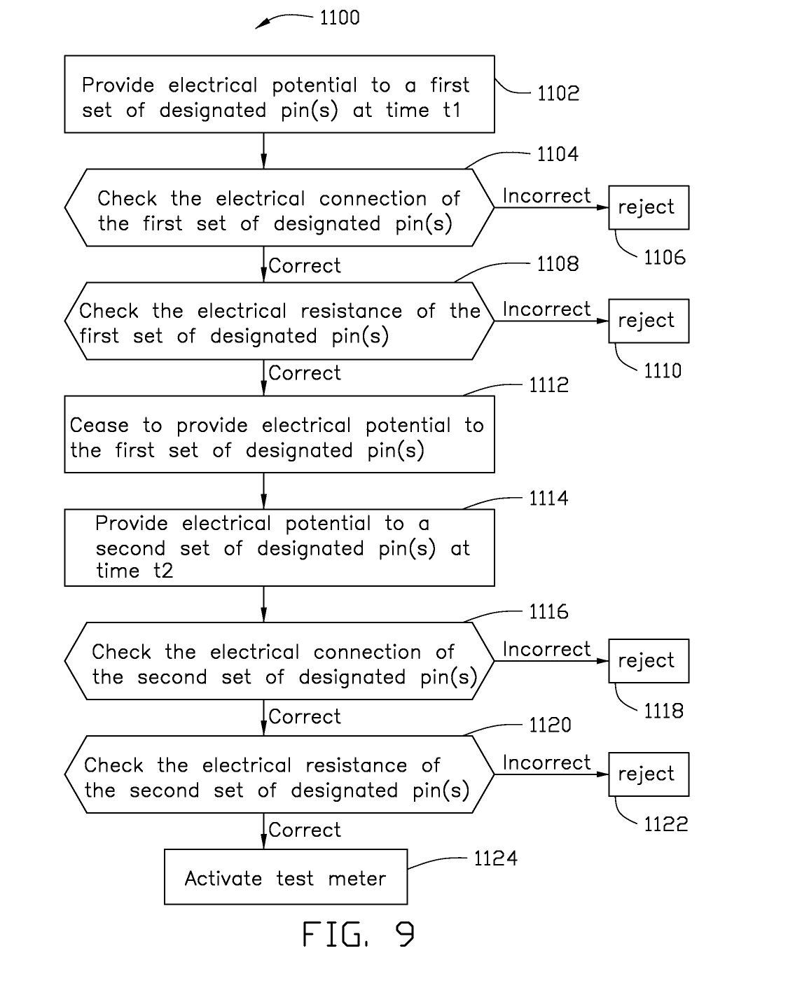

Furthermore, with reference to FIG. 9, the verification method 1100 with active electrical potential provision may be implemented by the biosensor monitor 100 detecting the electric resistance of the conductive pads that the pins are contacting. That is, the biosensor monitor 100 may verify the electric resistances of the conductive pads to ensure that the test strip 300 is a genuine one. Referring to FIG. 9, steps 1102 to 1106 are identical to steps 902-906 in the exemplary method in FIG. 7 and therefore will not be repeated. Thereafter, instead of ceasing to provide electrical potential to the first combination of pins, in step 1108, the biosensor monitor 100 may detect the electric resistance of the conductive pad connecting to pins 1 and 2 according to the value of the electric current received by pin 2. The biosensor monitor 100 may then compare whether such electric resistance conforms to a first predetermined value. If not conforming, the test strip 300 may be rejected and the biosensor monitor 100 may not be activated, as illustrated in step 1110. On the other hand, if the first predetermined condition is fulfilled and the electric resistance conforms to the first predetermined value, the biosensor monitor 100 may cease to provide electrical potential to the first combination of pins in step 1112. Next, the biosensor monitor 100 may provide electrical potential to the second combination of pins, i.e., the pins 3 and 4, at time t2, as in step 1114. Thereafter, the biosensor monitor 100 continues the electrical connection verification and the electric resistance verification. The methods implemented in steps 1116-1122 are identical to those steps 1104-1110 and thus will not be repeated herein. In step 1124, after the biosensor monitor 100 verifies that all the conditions are fulfilled in sequence and the electric resistances detected satisfy the predetermined values in sequence, the biosensor monitor 100 will be activated from the sleep mode or the power saving mode. Accordingly, a verification method with active electrical potential provision designed to detect electric resistance is provided. Alternatively, steps 1104, 1106, 1116 and 1118 in the present method of this embodiment may be omitted. That is, the electrical connection verification feature may be omitted. Consequently, the verification method may be implemented by only sequentially verifying the electric resistance of the conductive pads contacting the pins. Therefore, a verification method by detecting the electric resistance of the conductive pads with active electrical potential provision is provided.

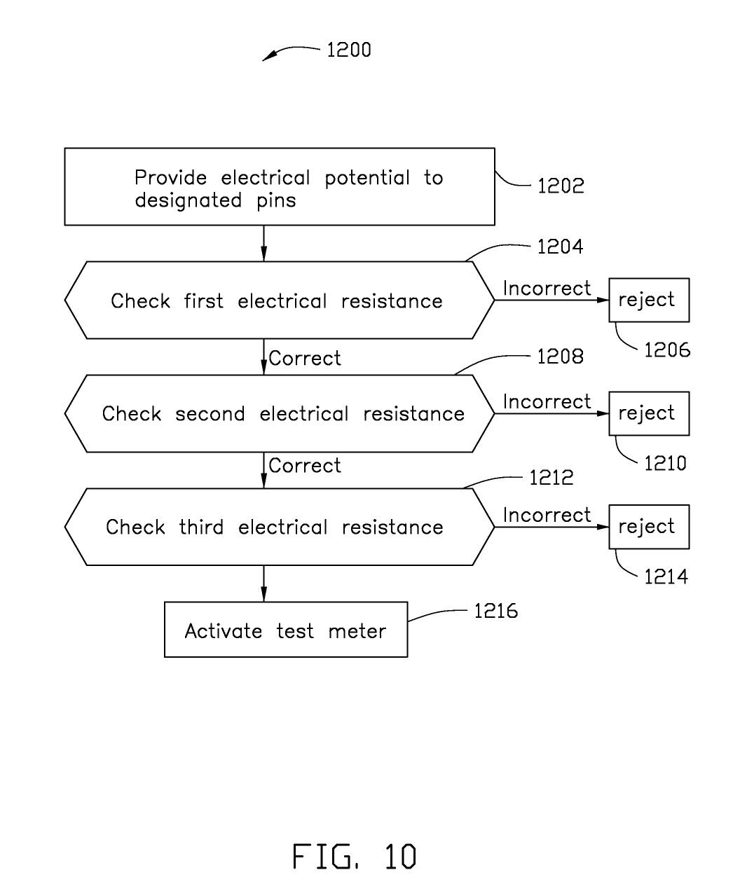

Similarly, as shown in FIG. 10, the verification method 1200 with passive electrical potential provision may be implemented by the biosensor monitor 100 detecting the electric resistance of the conductive pads that the pins are contacting. That is, the biosensor monitor 100 may verify the electric resistances of the electrodes to ensure that the test strip 300 is a genuine one. In detail, with reference to FIG. 10, when the biosensor monitor 100 is in the sleep mode or the power saving mode, the biosensor monitor 100 provides electrical potential to designated pins in step 1202. In particular, the voltage at pin 2 may be lower than that at pin 1, the voltage at pin 3 may be lower than that at pin 2, and the voltage at pin 4 may be lower than that at pin 3. For exemplary, the voltage may be 10V at pin 1, 7V at pin 2, 3V at pin 3, and zero (grounded) at pin 4. In step 1204, when the pins 1 and 2 are in contact with a conductive pad 25, the biosensor monitor 100 may detect an electric current flowing from pin 1 to pin 2. The biosensor monitor 100 may then detect the electric resistance of the electrode connecting to pins 1 and 2 according to the value of the electric current received by pin 2. Next, the biosensor monitor 100 may compare whether such electric resistance conforms to a first predetermined value. If not conforming, the test strip 300 may be rejected and the biosensor monitor 100 will not be activated, as illustrated in step 1206. On the other hand, if the electric resistance conforms to the first predetermined value, the biosensor monitor 100 may continue to perform the activation method. In step 1208, when the pins 3 and 4 are in contact with one electrode, the biosensor monitor 100 may detect an electric current flowing from pin 3 to pin 4. The biosensor monitor 100 may then detect the electric resistance of the electrode connecting to pins 3 and 4 according to the value of the electric current received by pin 4. Next, the biosensor monitor 100 may then compare whether such electric resistance conforms to a second predetermined value. If not conforming, the test strip 300 may be rejected and the biosensor monitor 100 may not be activated, as illustrated in step 1210. On the other hand, if the electric resistance conforms to the second predetermined value, the biosensor monitor 100 may continue to perform the activation method. In step 1212, when the pins 2, 3 and 4 are in contact with a conductive pad 28, the biosensor monitor 100 may detect an electric current flowing from pin 2 to pin 3, from pin 3 to pin 4, or from pin 2 to pin 4. The biosensor monitor 100 may then detect the electric resistance of the conductive pad 28 connecting to pins 2, 3 and 4 according to the value of the electric current received by pin 3 from pin 2, by pin 4 from pin 3, or by pin 4 from pin 2. Next, the biosensor monitor 100 may compare whether such electric resistance conforms to a third predetermined value. If not conforming, the test strip 300 may be rejected and the biosensor monitor 100 may not be activated, as illustrated in step 1214. On the other hand, if the electric resistance conforms to the third predetermined value, the biosensor monitor 100 may be activated from the sleep mode or the power saving mode in step 1216 and serves to measure the voltage or current across the electrodes 301, 302 and 303 when the blood sample is mixed or reacted with the reaction enzyme or reaction reagent. The sequential fulfillments of the first, second and third predetermined values represent that the source of the test strip 300 inserted is correct.

Therefore, a verification method by detecting the electric resistance of the electrodes with passive electrical potential provision is provided.

It is to be noted that the test strips or the biosensor monitor 100 implementing the activation mechanism is not so limited. Below are further exemplary embodiments of the test strips or the biosensor monitor 100 capable of implementing the activation mechanism disclosed herein.

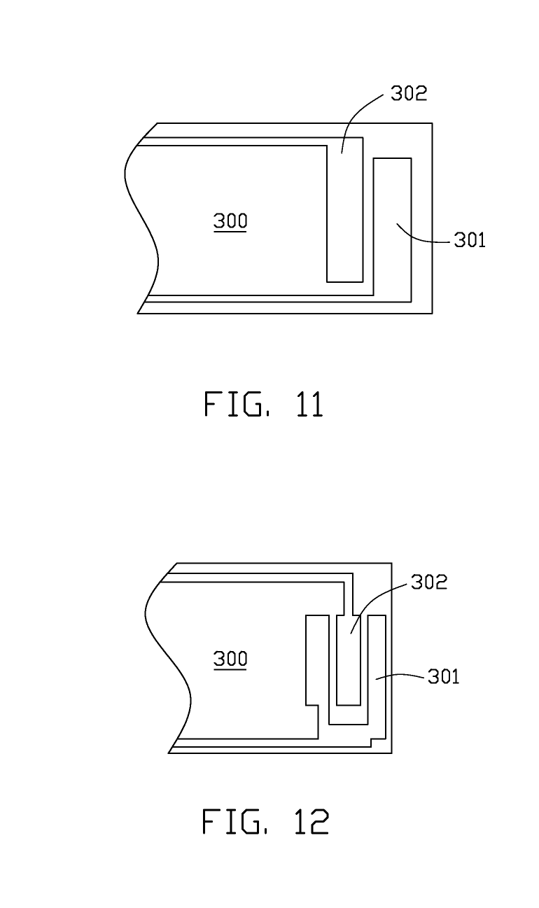

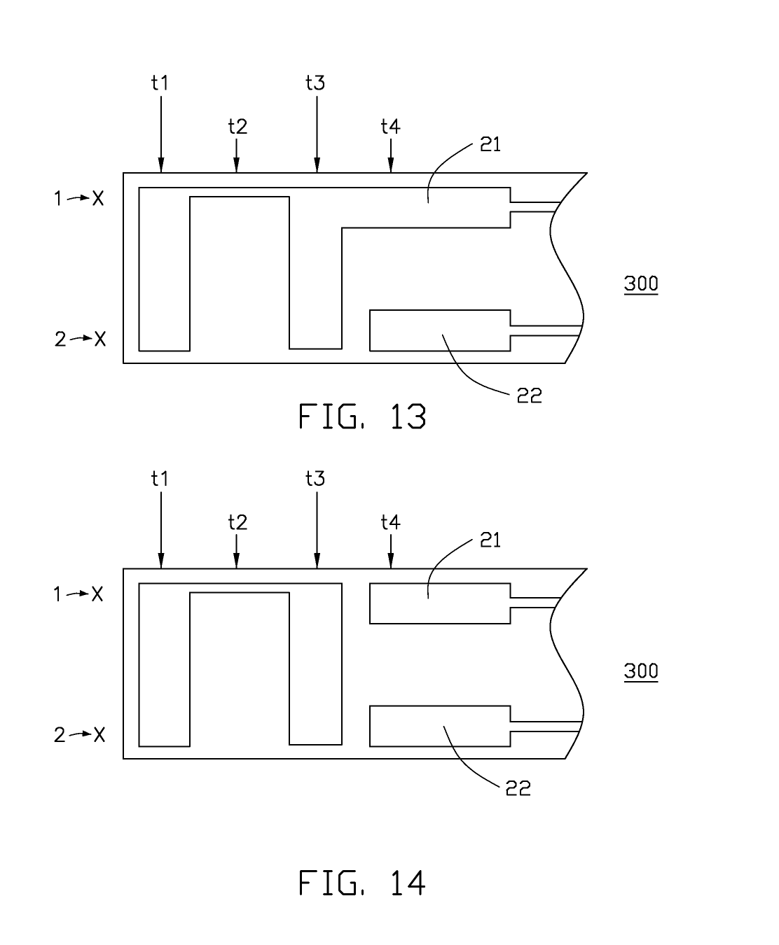

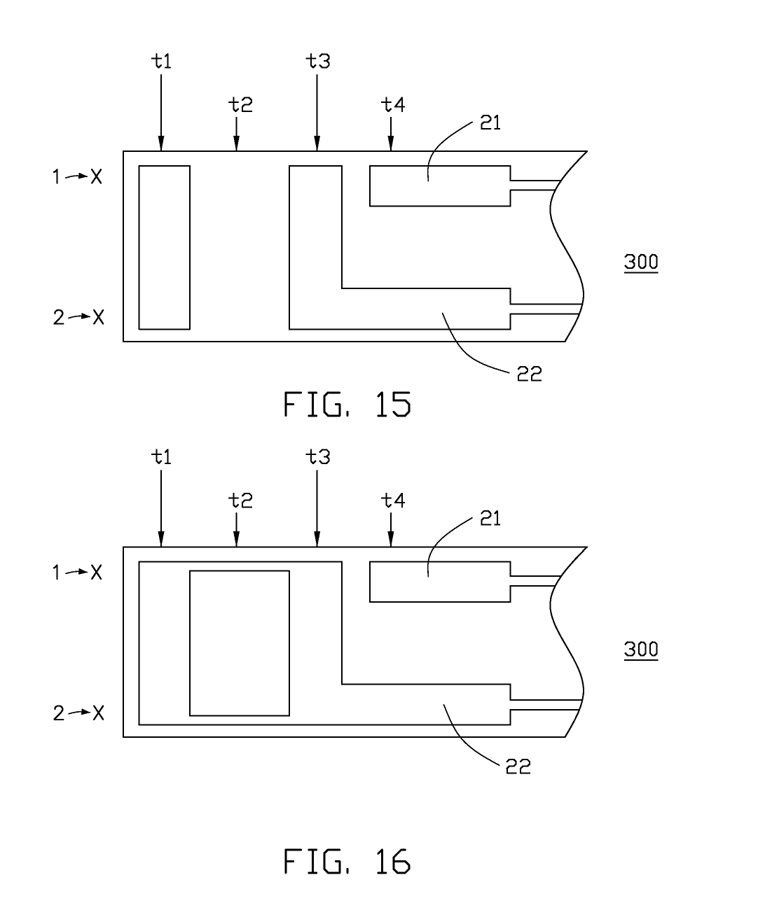

FIGS. 11-18 are illustrative views of exemplary test strips. For clarity, the left portions of FIGS. 11 and 12 and the right portions of FIGS. 13-18 are omitted. FIG. 11 illustrates a first portion of the test strip 300 having electrodes 301 and 302. The electrodes 301 and 302 may be used to measure the voltage or current across them when the blood sample is applied to the test strip and mixed or reacted with the reaction enzyme or reagent. The electrodes 301 and 302 can have other shapes or configurations, as illustrated in FIG. 12.

FIGS. 13-18 illustrate exemplary embodiments of the second portion of the test strip 300. The second portion may be combined with the first portion previously described to form a complete test strip. As illustrated, the second portions may comprise conductive pads 21 and 22, and other conductive pads to implement the activation mechanism previously discussed. For exemplary, in FIG. 13, the source of the test strip may be identified as (1) an electrical connection between the pins 1 and 2 at time t1, (2) no electrical connection between the pins 1 and 2 at time t2, and (3) an electrical connection between the pins 1 and 2 at time t3. If the biosensor monitor 100 finds this source acceptable, it may be activated and wakes up from the sleep mode or power saving mode.

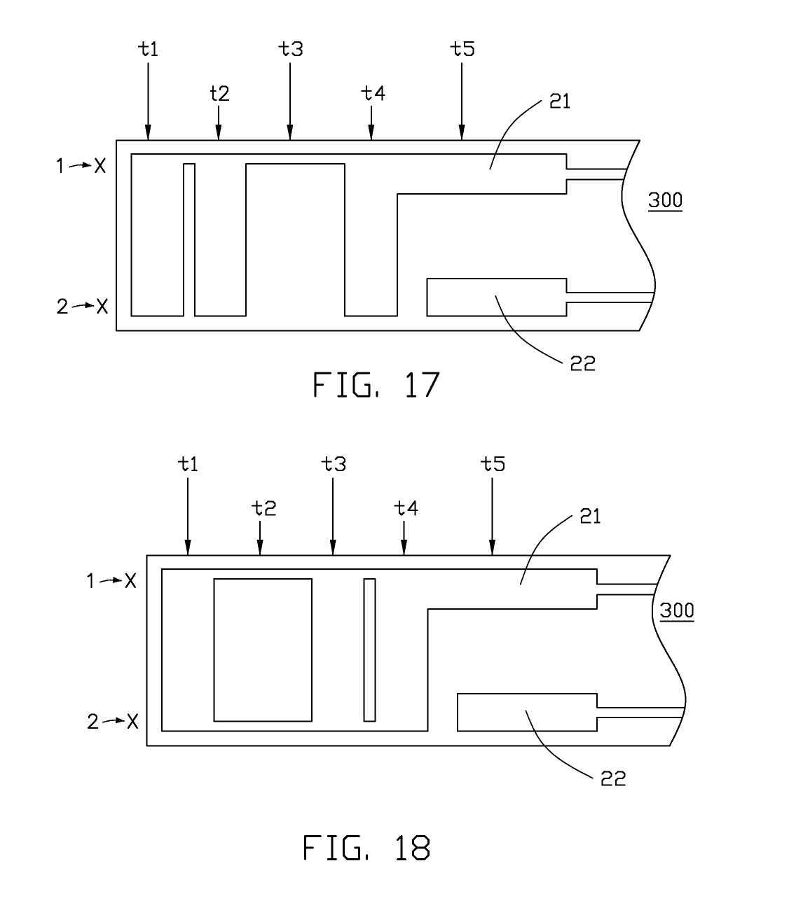

It should be noted that other arrangements of conductive pads may also be employed by the activation mechanism, as illustrated in FIGS. 14-16, as long as such arrangements may enable the first, second, and third conditions to be satisfied. Moreover, in FIGS. 17 and 18, the test strips 300 may comprise additional conductive pads to allow the biosensor monitor 100 to check an additional condition at time t4. A person of ordinary skill in the art would appreciate that these additional conductive pads may allow the biosensor monitor 100 to perform a more complex verification process.

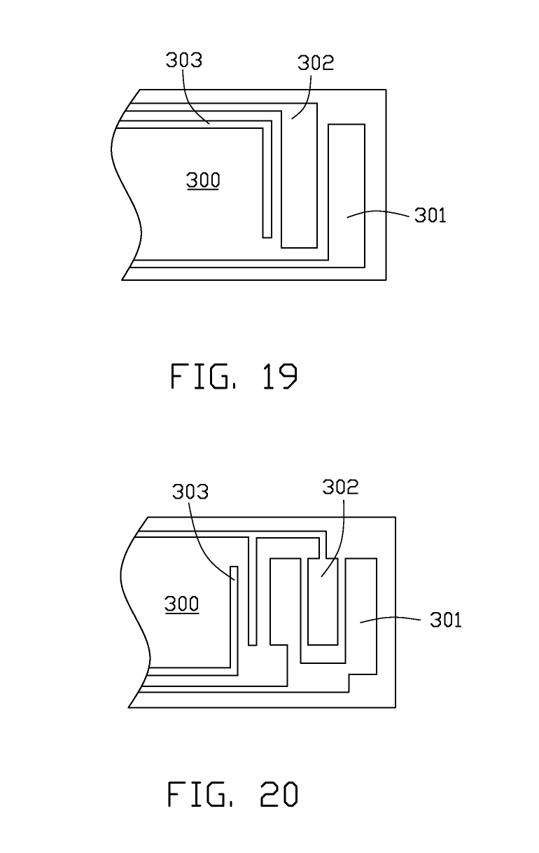

FIGS. 19-20 are illustrative views of exemplary test strips. FIG. 19 illustrates a first portion of the test strip 300 having electrodes 301, 302 and 303. The electrodes 301 and 302 may be used to measure the voltage or current across them when the blood sample is applied to the test strip and mixed or reacted with the reaction enzyme or reaction reagent. In addition, electrode 303 may be used to detect the amount of the blood sample. For exemplary, when the amount of the blood sample is insufficient, the blood sample may not contact electrode 303. If this happens, the biosensor monitor 100 may display a warning message.

A person of ordinary skill in the art would appreciate that the shapes of the electrode 301, 302 and 303 may have various shapes. For exemplary, FIG. 20 demonstrates another exemplary embodiment of the first portion of the test strip 300.

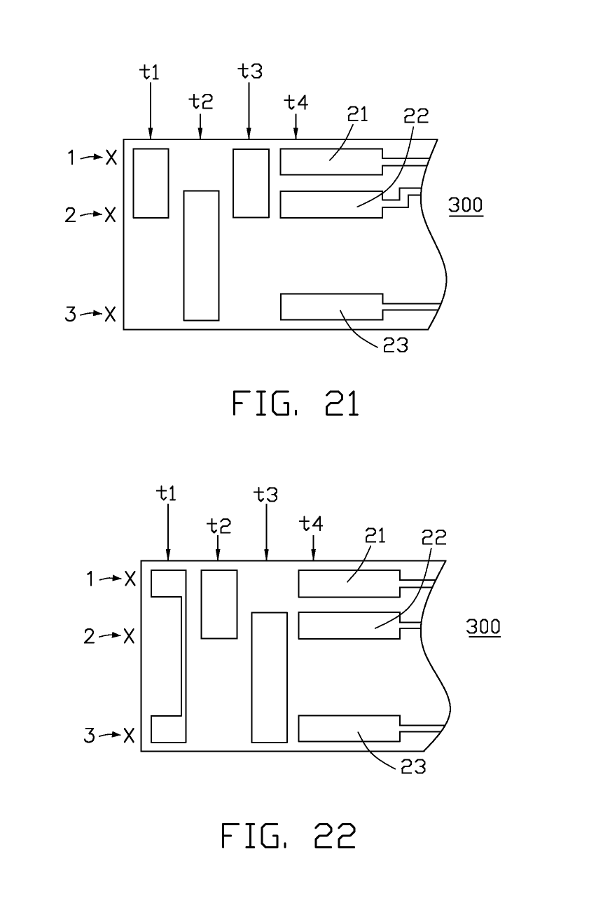

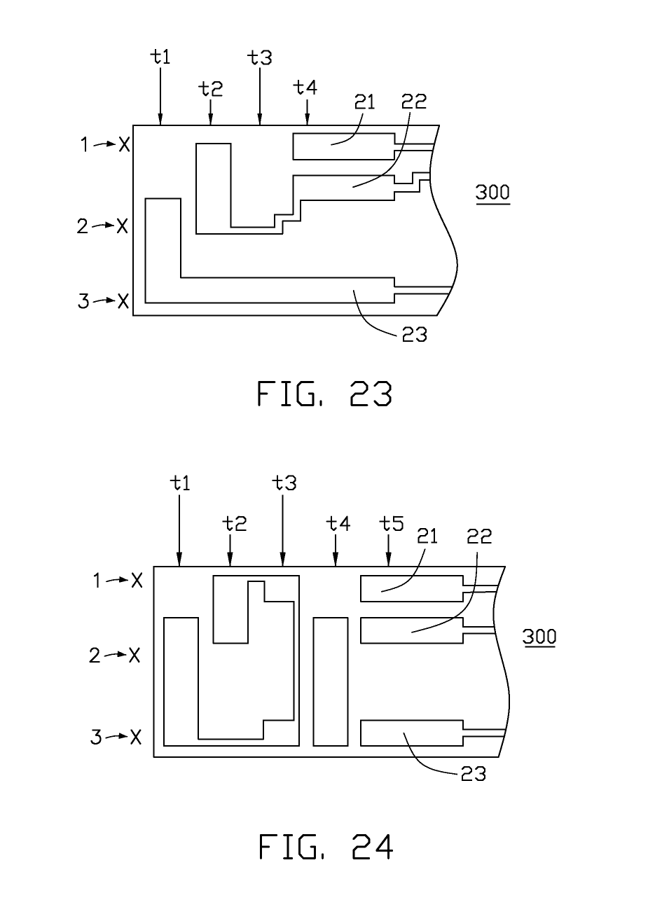

FIGS. 21-24 illustrate exemplary second portions of the test strip 300. These second portions may comprise conductive pads 21, 22 and 23, and other conductive pads to implement the activation mechanism. Accordingly, the biosensor monitor 100 may utilize the activation mechanism previously discussed to verify the source of the inserted test strip 300. For exemplary, in FIG. 21, the source of the test strip 300 may be identified as (1) an electrical connection between the pins 1 and 2 at time t1, (2) an electrical connection between the pins 2 and 3 at time t2, and (3) an electrical connection between the pins 1 and 2 at time t3. Other arrangements, as illustrated in FIGS. 22-24, may be similarly implemented. In addition, as illustrated in FIGS. 23 and 24, a person of ordinary skill in the art would appreciate that additional conductive pads may be employed to allow the biosensor monitor 100 to perform a more complex verification process.

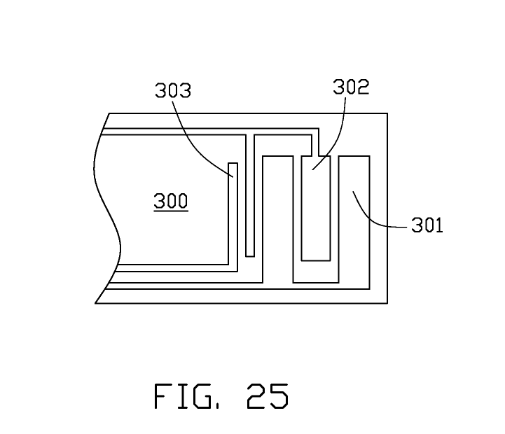

FIG. 25 is an illustrative view of an exemplary test strip. FIG. 25 illustrates a first portion of the test strip 300 having electrodes 301, 302 and 303. These electrodes may serve similar functions as previously discussed.

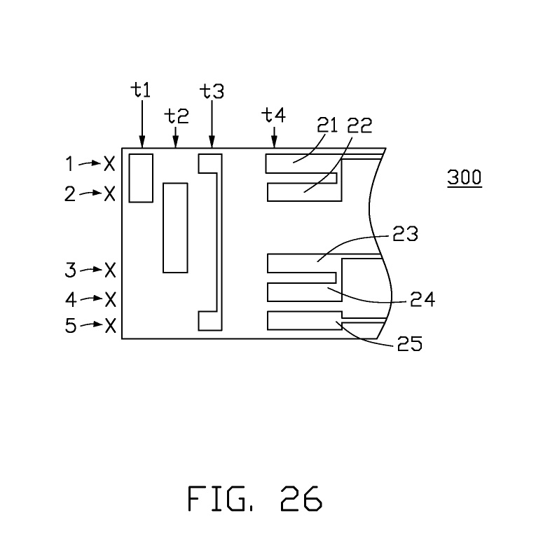

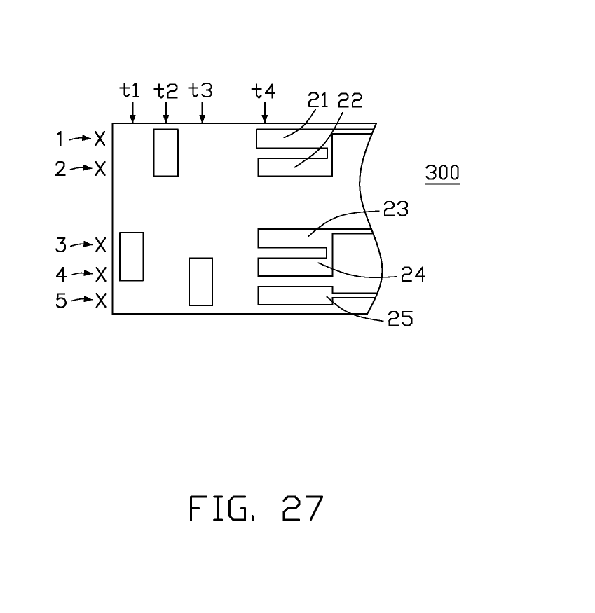

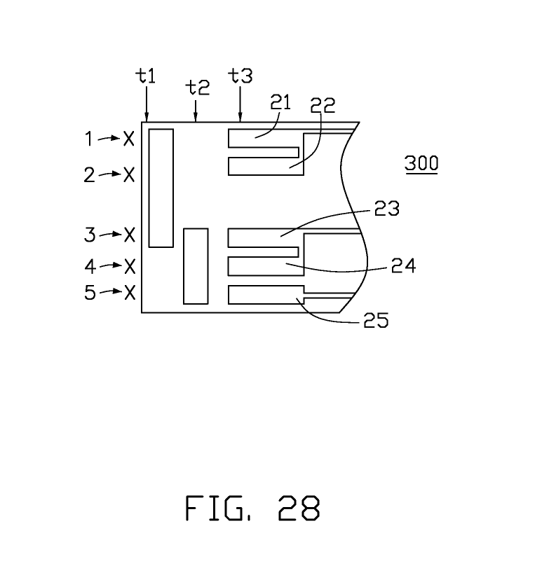

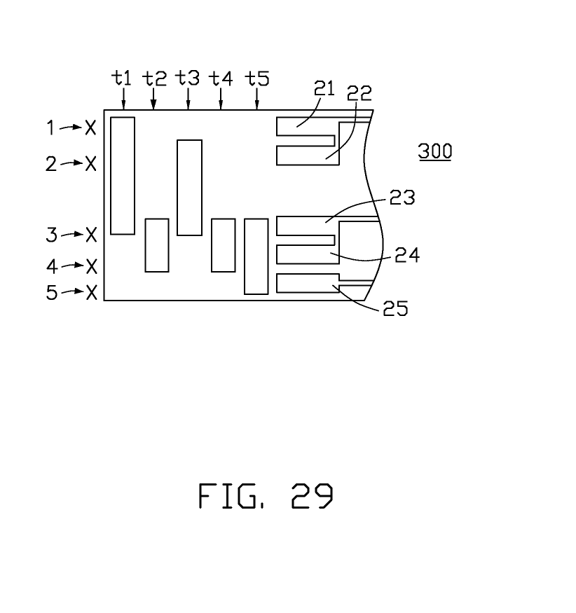

FIGS. 26-29 illustrate exemplary embodiments of the second portion of the test strip 300. These second portions may comprise conductive pads 21, 22, 23, 24 and 25, and other conductive pads to implement the activation mechanism previously discussed (refer to pins 1-4 above). For exemplary, in FIG. 26, the source of the test strip 300 may be identified as (1) an electrical connection between the pins 1 and 2 at time t1, (2) an electrical connection between the pins 2 and 3 at time t2, and (3) an electrical connection between the pins 1 and 5 at time t3. FIGS. 27-29 are embodiments illustrating different arrangements of conductive pads according to embodiments.

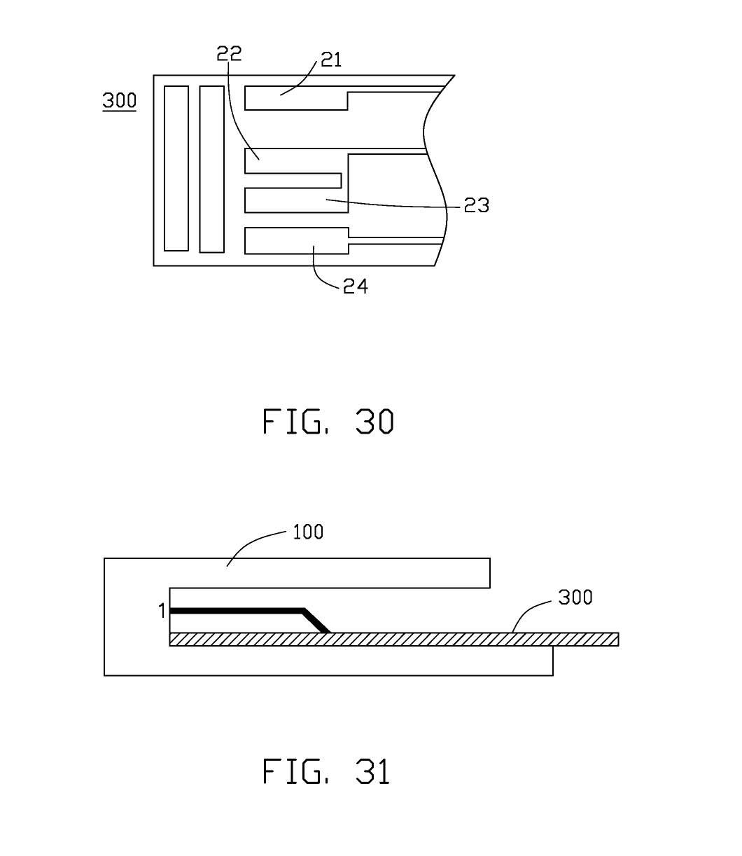

FIGS. 30-37 are illustrative views of exemplary embodiments of the test strip and the biosensor monitor 100. In FIG. 30, a second portion of the test strip 300 may comprise conductive pads 21, 22, 23 and 24, and two other conductive pads (not numbered). In FIG. 31, a sectional side view of the biosensor monitor 100 with the test strip 300 fully inserted is provided. In this embodiment, the biosensor monitor 100 may have as previously described four pins; though, in these figures only pin 1 is illustrated. The pins may be L-shaped so that only their tips may contact with the test strip 300. However, the pins may also have other shapes.

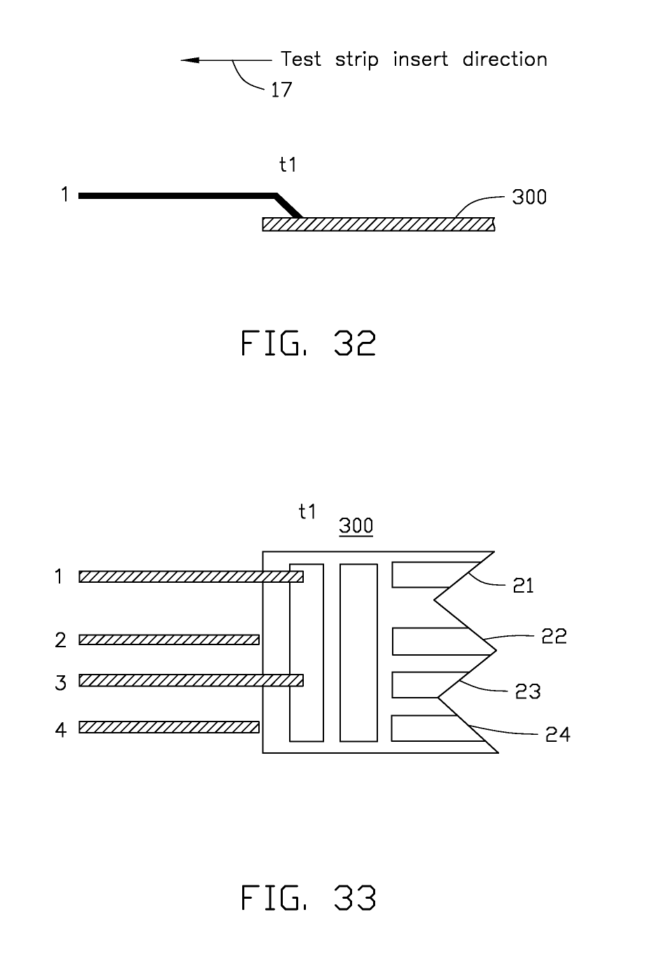

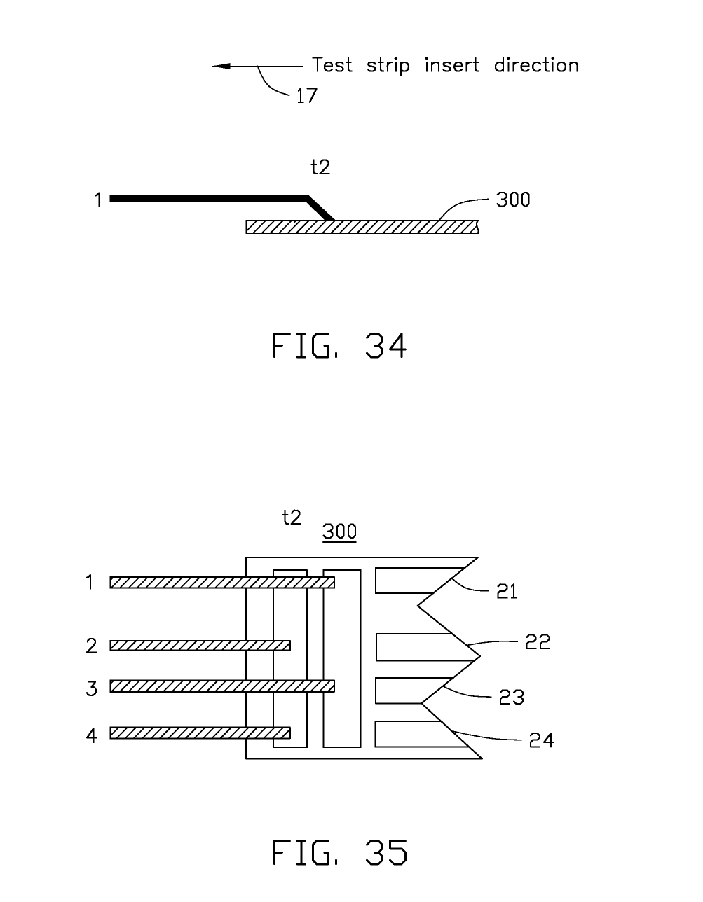

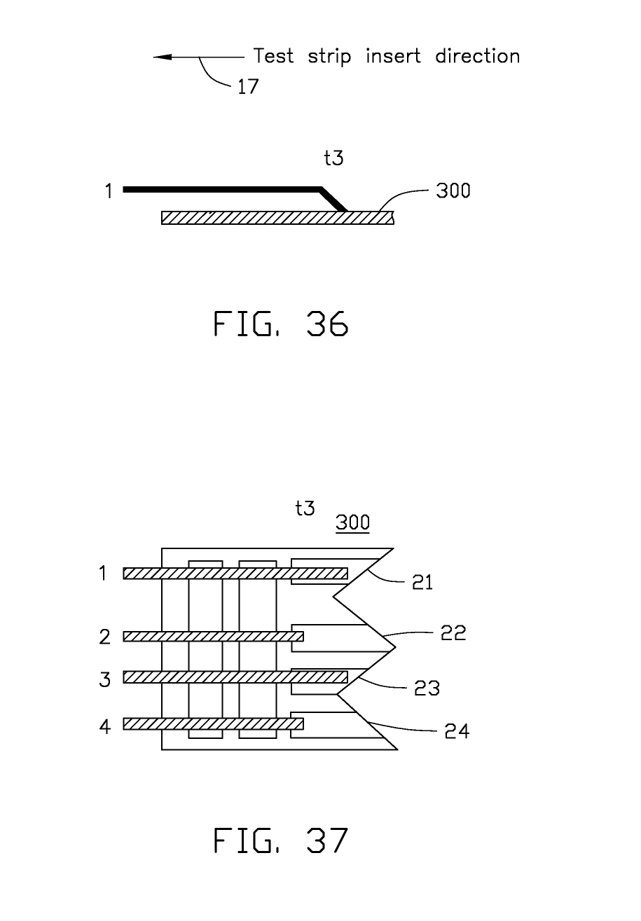

FIG. 32 is a sectional side view of the pin 1 and the test strip when the test strip is being inserted into the biosensor monitor 100 at time t1. FIG. 33 is the corresponding perspective top view of the pins and the test strip. Similarly, FIG. 34 is a sectional side view of the pin 1 and the test strip when the test strip is being inserted into the biosensor monitor 100 at time t2, and FIG. 35 is the corresponding perspective top view. In addition, FIG. 36 is a sectional side view of the pin 1 and the test strip when the test strip is being inserted into the biosensor monitor 100 at time t3, and FIG. 37 is the corresponding perspective top view.

In FIG. 33, at time t1, the pins 1 and 3 may be in contact with one conductive pad, thereby establishing an electrical connection between the pins 1 and 3. The biosensor monitor 100 may check such electrical connection with the first predetermined condition. At time t2, as illustrated in FIG. 35, the pins 1 and 3 may be in contact with one conductive pad, and the pins 2 and 4 may be in contact with another conductive pad. Therefore, electrical connections may be established between the pins 1 and 3, and between the pins 2 and 4. The biosensor monitor 100 may check such electrical connections with the second predetermined condition. At time t3, as illustrated in FIG. 37, the pins 1, 2, 3 and 4 may be in contact with the conductive pads 21, 22, 23, and 24 respectively. If the first and second predetermined conditions have been satisfied, the biosensor monitor 100 may be activated and wake up from the sleep mode or power saving mode. A person of ordinary skill in the art would appreciate that the configurations of pins and conductive pads may be adjusted to accommodate the desired complexity of the activation mechanism.

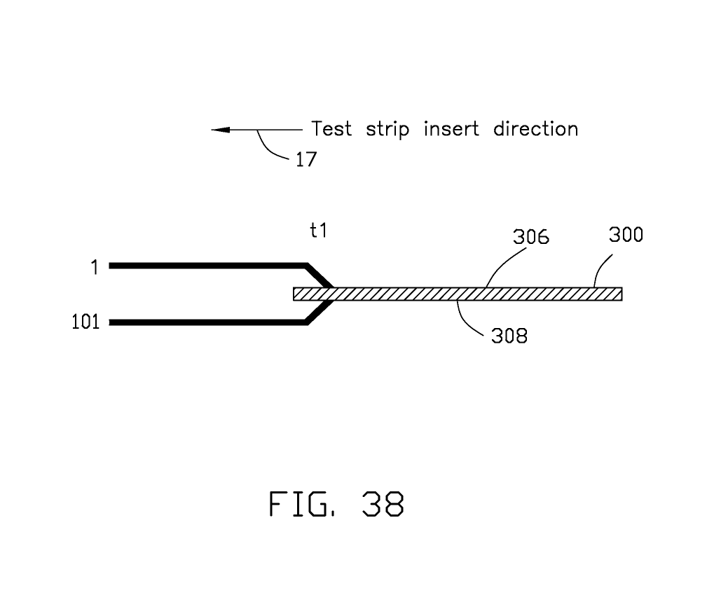

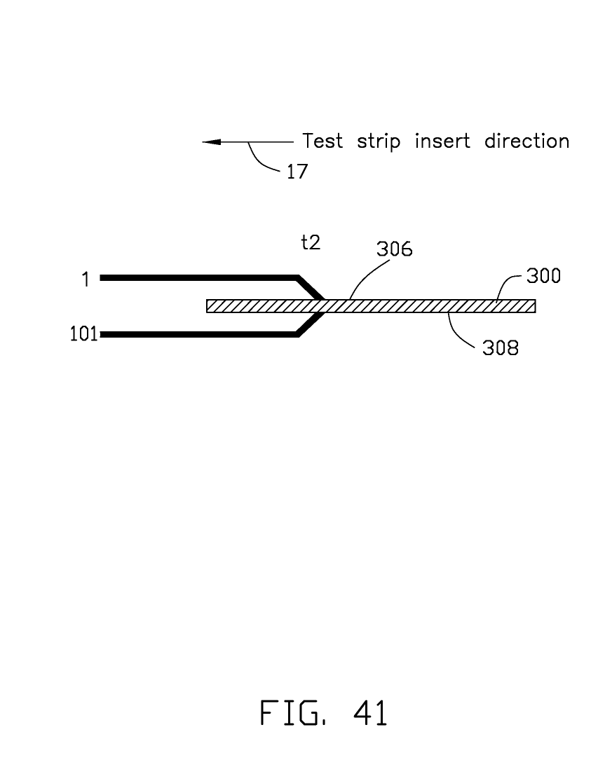

FIGS. 38-45 are illustrative views of exemplary embodiments of the test strip and the biosensor monitor 100. In these exemplary embodiments, conductive pads used by the activation mechanism may be formed on both sides of a test strip. For exemplary, a conductive pad formed on one side of the test strip can penetrate through the test strip and be exposed on the other side.

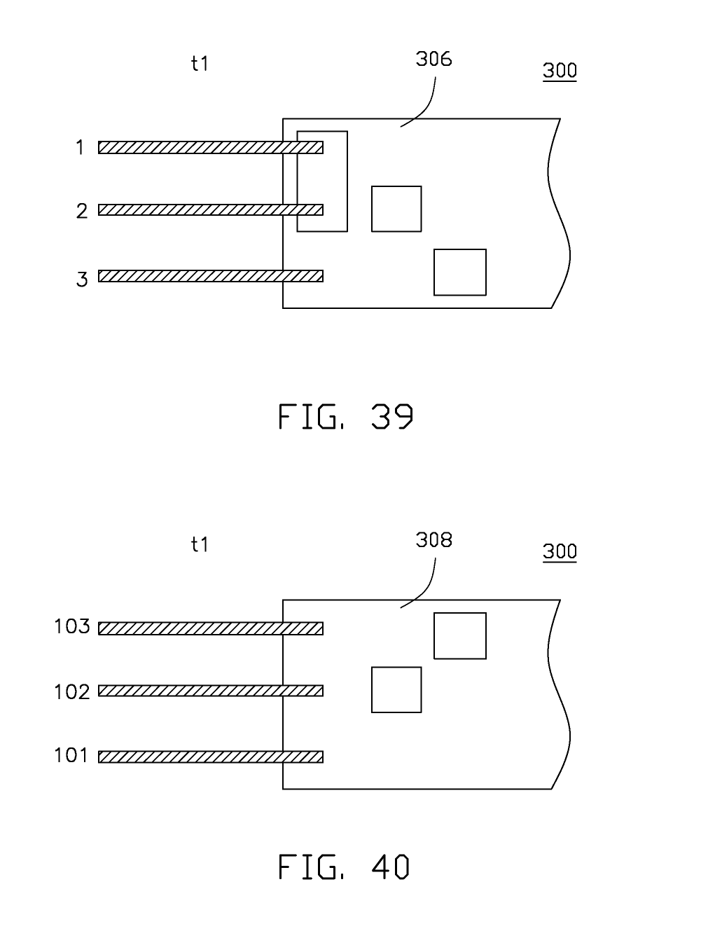

In FIG. 38, the test strip is placed between the pins 1 and 101. Similarly, in FIGS. 39-40, the biosensor monitor 100 may be placed between the pins 2 and 102, and between the pins 3 and 103. According to an embodiment, the pins 1 and 101 may have similar shapes. For the purpose of clarity, in FIG. 38, only the pins 1 and 101 are illustrated.

As illustrated in FIG. 38, at time t1, when the test strip 300 is being inserted in to the biosensor monitor 100, the pin 1 contacts a first surface 306 of the test strip 300 and the pin 101 contacts a second surface 308 of the test strip 300. At this time, as illustrated in FIG. 39, the pins 1 and 2 are electrically connected. Similarly, as illustrated in FIG. 40, no electrical connection is formed among the pins 101, 102 and 103. The biosensor monitor 100 may check such electrical connection with the first predetermined condition

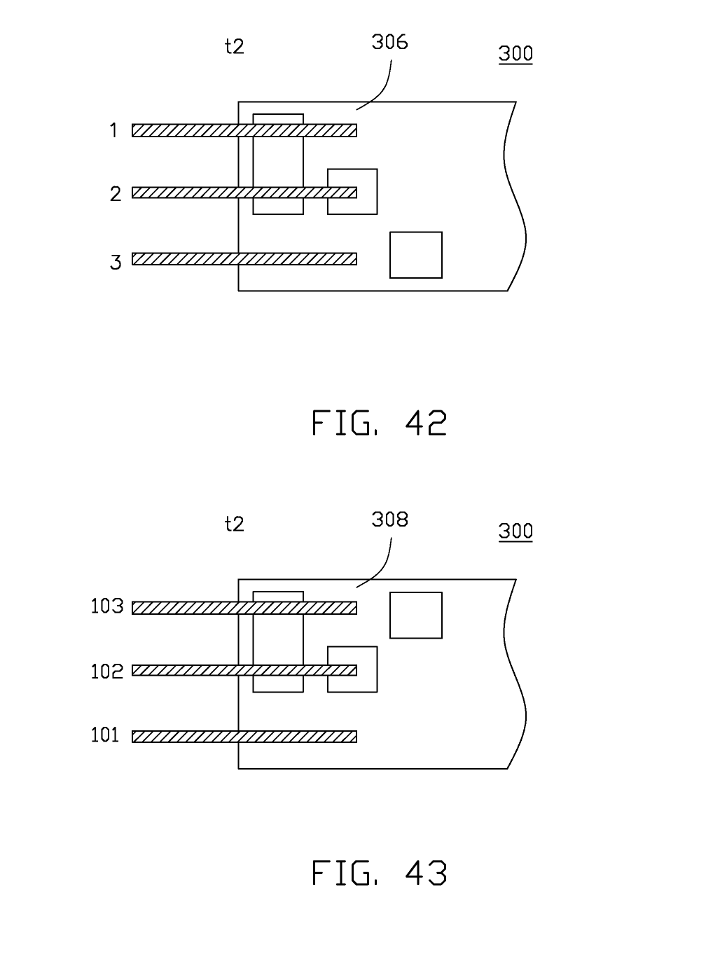

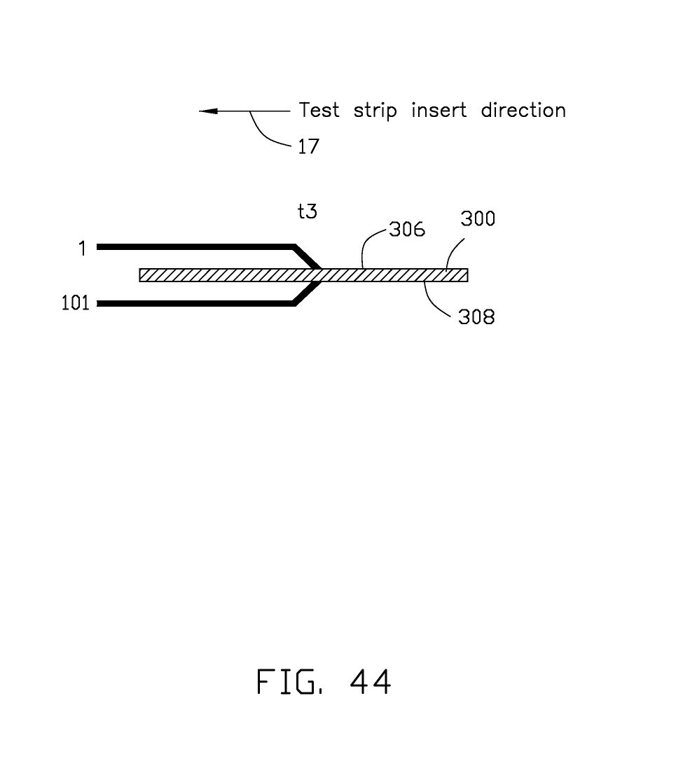

At time t2, as illustrated in FIG. 42, the test strip 300 is further inserted into the biosensor monitor 100. At this time, as illustrated in FIGS. 43 and 44, because the pins 2 and 102 are in contact with the same conductive pad, an electrical connection is established between the pins 2 and 102. The biosensor monitor 100 may check such electrical connection with the second predetermined condition.

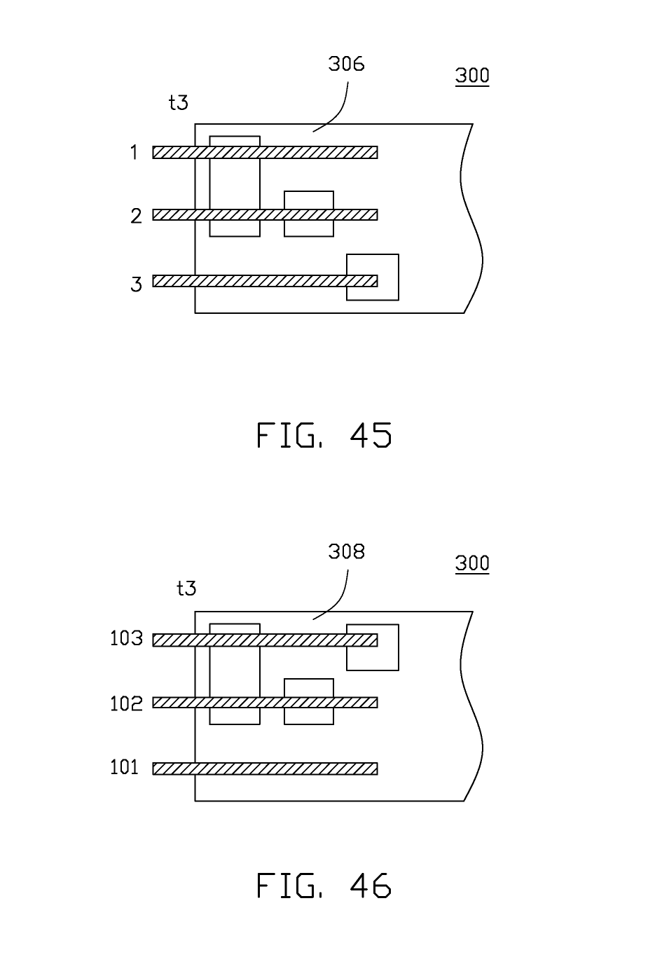

At time t3, as illustrated in FIG. 44, the test strip 300 is yet further inserted into the biosensor monitor 100. At this time, as illustrated in FIGS. 45-46, because the pins 3 and 103 are in contact with the same conductive pad, an electrical connection is established between the pins 3 and 103. The biosensor monitor 100 may check such electrical connection with the third predetermined condition. Finally, if the first, second, and third predetermined conditions have been satisfied, the biosensor monitor 100 may be activated.

As previously described, the source of the inserted test strip may be verified by checking whether the electrical characteristics of the pins satisfy a default condition. For exemplary, the biosensor monitor 100 may check the electrical connections among a set of designated pins, as depicted in the methods of FIGS. 7 and 10. It may also check the electrical resistance values between two designated pins, as depicted in FIGS. 9 and 10. It may also apply a voltage on a designated pin, and then measure an electrical characteristic between the designated pin and another designated pin, as depicted in FIG. 8. Moreover, it may further conduct the test at a subsequent time on another pair of designated pins, as depicted in FIG. 7.

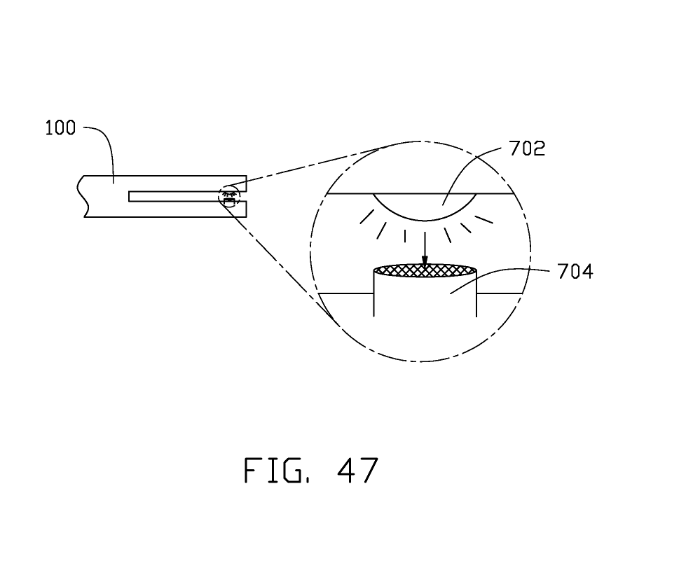

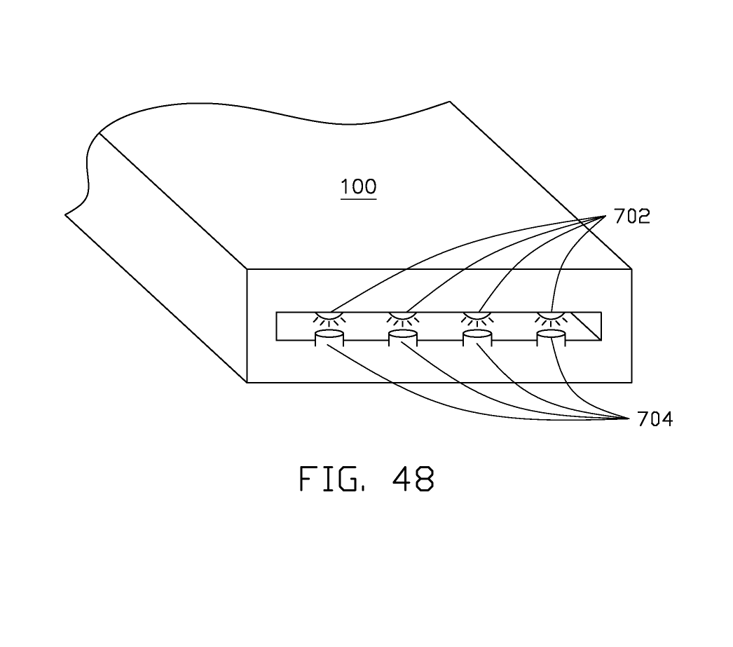

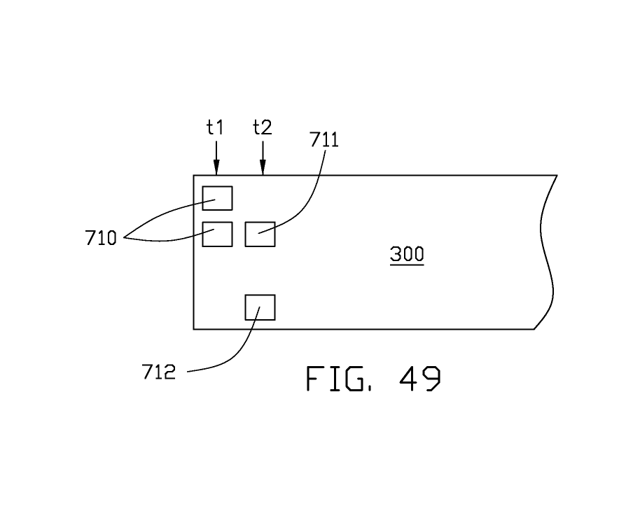

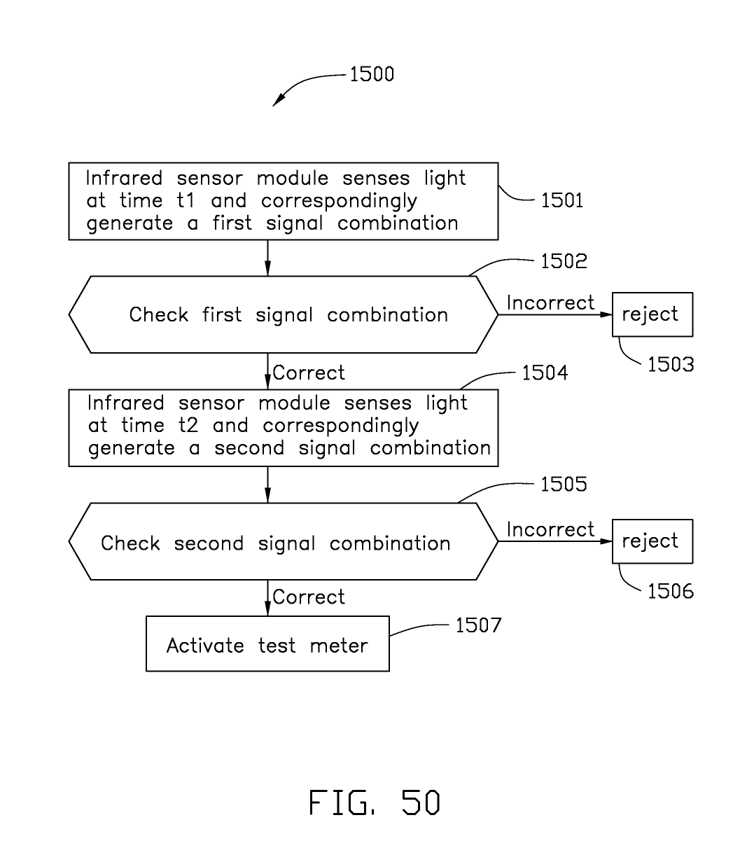

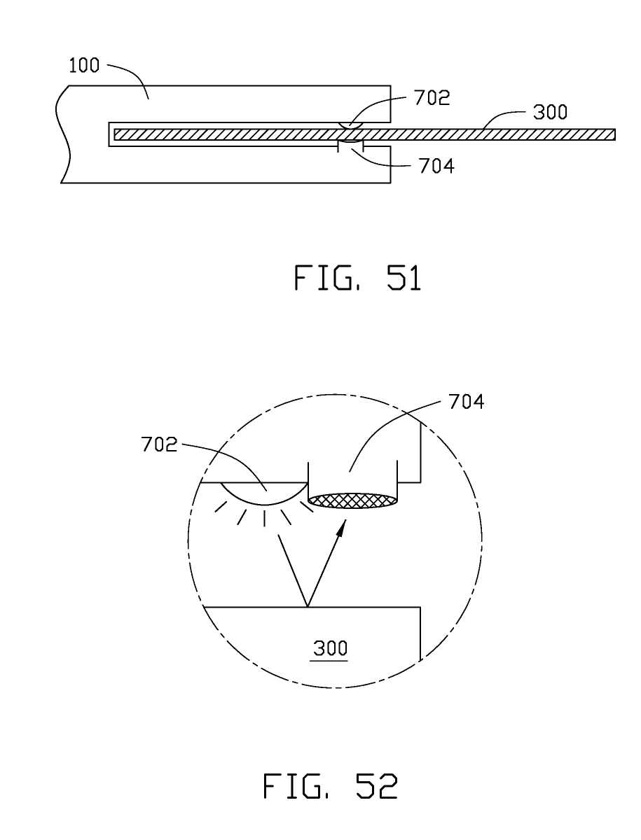

Alternatively, the source of the inserted test strip may be verified by checking whether the optical characteristics of the test strip satisfy a default condition. For example, as illustrated in FIGS. 47-49, the source of the test strip may be represented by the locations of the holes 710 on the test strip 300. These locations may be determined by the light sources 702 and sensor modules 704. For example, in FIGS. 47-49, it is determined if light projected by the light source 702 can be sensed by the sensor module 704 (such as infrared sensor module). Thus, when the test strip is inserted, the sensor modules 704 in FIGS. 47-48 will provide the information needed to determine the hole configuration. For exemplary, as illustrated in FIGS. 49 and 50, in the exemplary method 1500, at time t1, the first sensor module and the second sensor module may transmit the “ON” signals to represent the existence of the top two holes 710 (the first signal combination, as shown in steps 1501 and 1502). At time t2, the second sensor module and the fourth sensor module may transmit the “ON” signals to represent the existence of the third hole 711 and the fourth hole 712 (the second signal combination, as shown in steps 1504 and 1505). Then, if the first and second signal combinations are deemed acceptable, the biosensor monitor 100 may be activated (as shown in step 1507).

Accordingly to another embodiment, as illustrated in FIGS. 51-52, the source of the test strip 300 may be represented by the configuration of the reflective pads, whose locations may similarly be determined by the light source 702 and the sensor module 704.

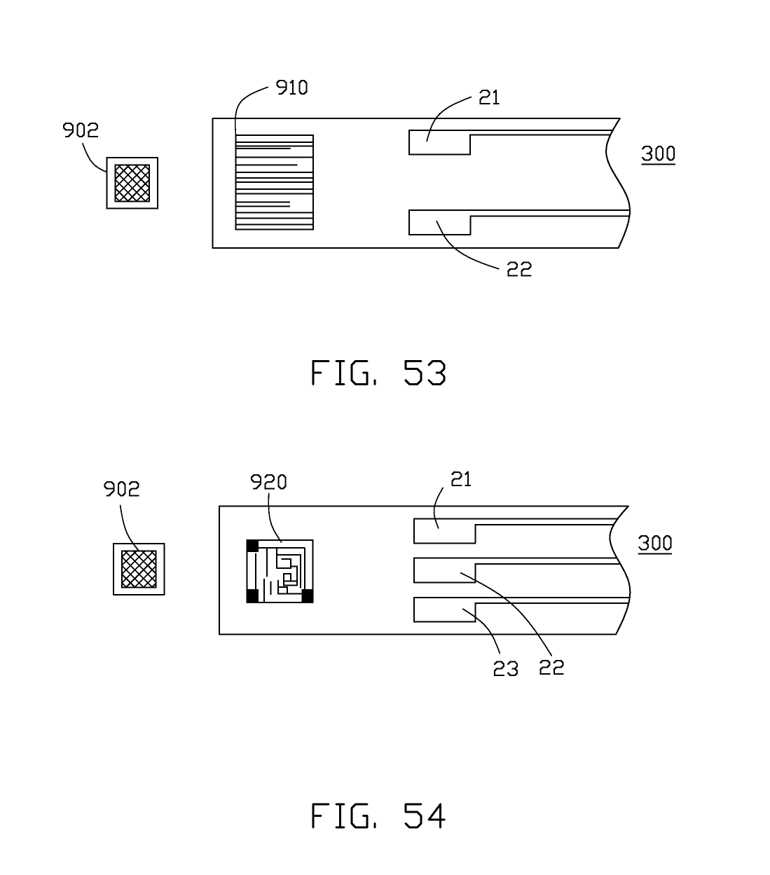

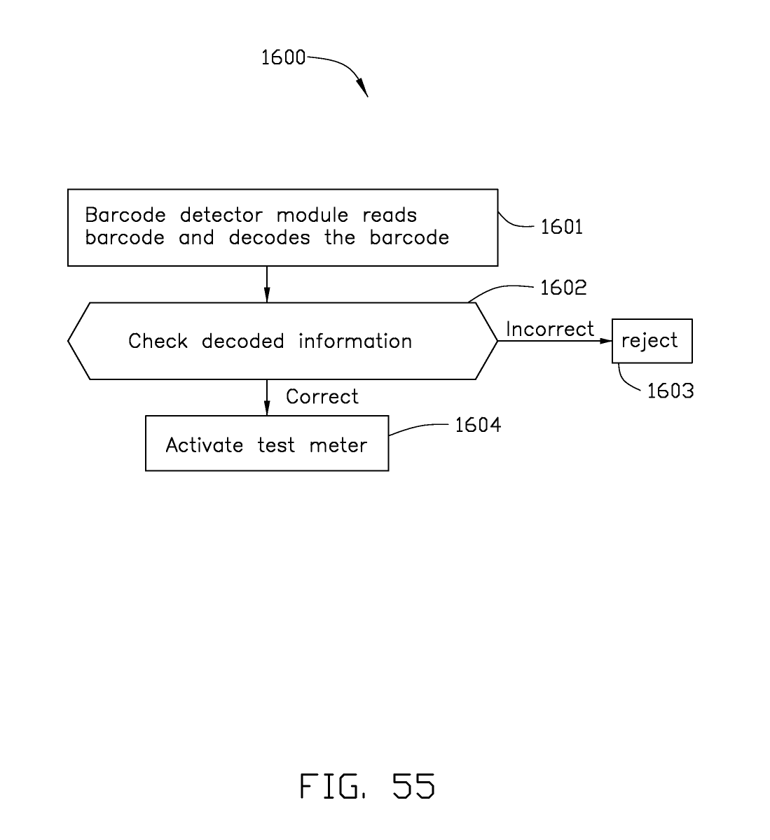

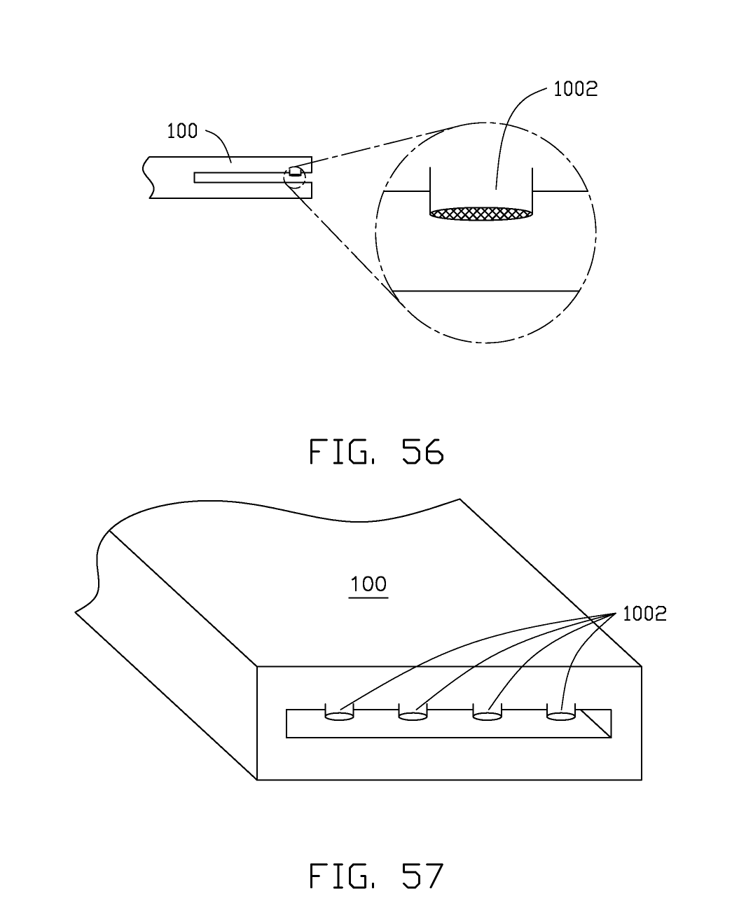

Accordingly to another exemplary embodiment, as shown in FIGS. 53-54, the verification portions 310 of the test strip 300 may be represented by the barcode printed thereon. The verification components 125 of the biosensor 100 may comprise barcode readers. This barcode (910 in FIGS. 53 and 920 in FIG. 54) may be read by the method 1600 of FIG. 55. In step 1601, using detector module 902 (such as barcode detector module), the barcode can be decoded. If the decoded information is acceptable, the biosensor monitor 100 will be activated (as shown in steps 1602 and 1604 of FIG. 55). If the decoded information is unacceptable, the biosensor monitor 100 will not be activated (as shown in step 1603) and the strip rejected. The barcode may, for exemplary, be a one-dimensional barcode 910 in FIG. 52, or a two-dimensional barcode 920 in FIG. 53.

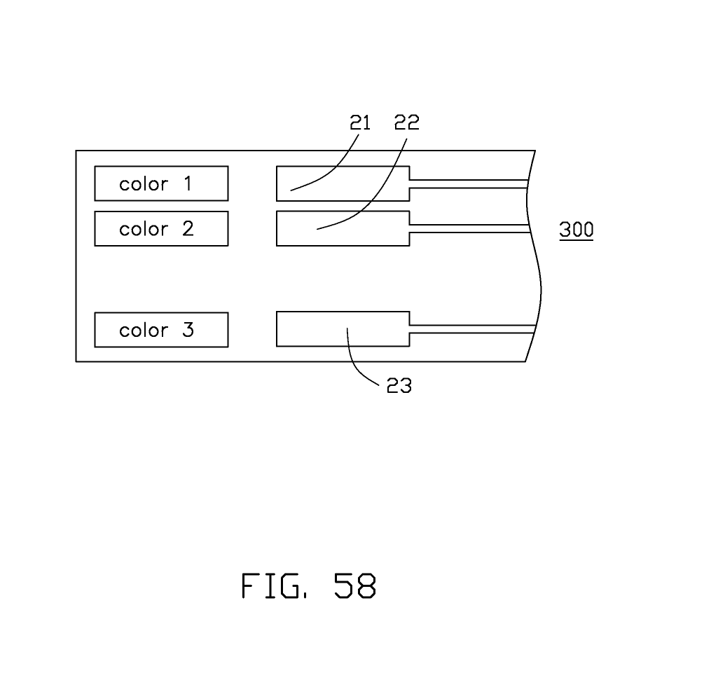

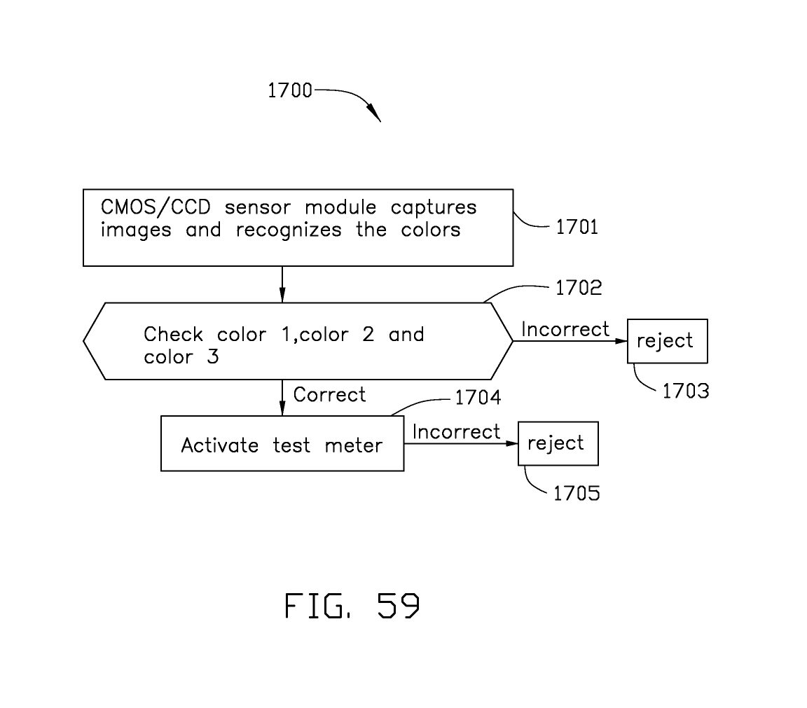

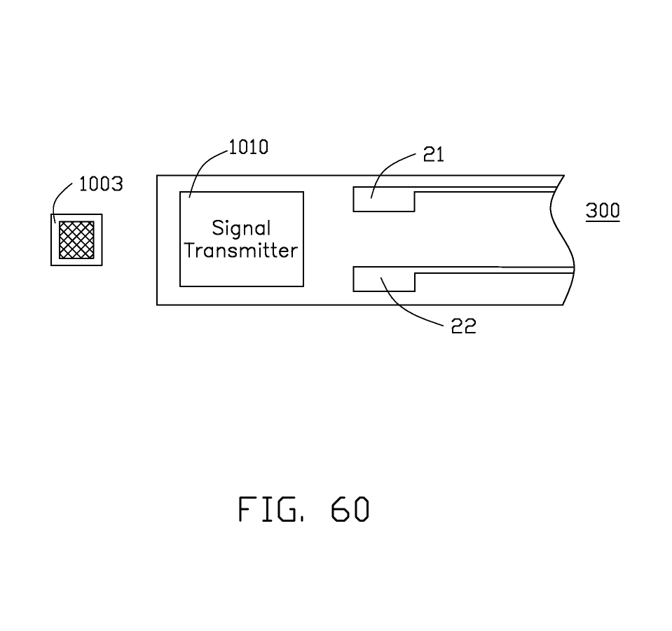

Accordingly to another exemplary embodiment, the source of the test strip may be represented by the color pattern printed thereon. This color pattern may be read by the sensor modules 1002 (such as CMOS/CCD sensor module) in FIGS. 56-57, and be subsequently used to determine if the biosensor monitor 100 shall be activated. The color pattern may comprise the colors of the blocks (such as red, blue, or yellow) (FIG. 58), or the shape and size associated with each block. As illustrated in exemplary method 1700 shown in FIG. 59, in step 1701, when the test strip is inserted, the sensor module 1002 may capture the images and recognize the associated colors (color 1, color 2, and color 3). Then, the biosensor monitor 100 may check whether the recognized colors are acceptable (1702). If so, the biosensor monitor 100 may be activated 1704. Otherwise, the strip will be rejected (1705).

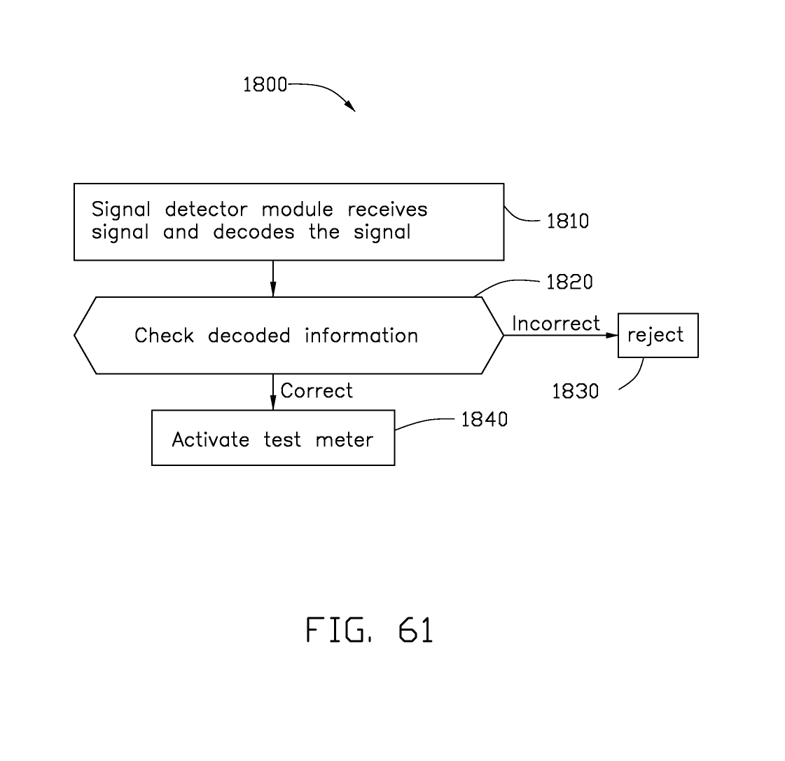

Accordingly to another embodiment, as shown in FIGS. 60-61, the verification portions 310 of the test strip 300 may be represented by at least one signal transmitter 1010 thereon and the verification components 125 of biosensor 100 can be a signal detector 1003. According to method 1800, in step 1810, the at least one signal transmitter would send out at least one signal and the at least one signal is then received by the signal detector module 1003 of biosensor 100 and is subsequently decoded. If the decoded information is unacceptable, the strip will be rejected and biosensor monitor 100 will not be activated (as shown in step 1830 of FIG. 61). If the decoded information is acceptable, the biosensor monitor 100 will be activated (as shown in step 1840 of FIG. 61). The signal described here can be passively and/or actively generated. The signal transmission described here can involve, but not limited to, a near-field communication (NFC), BLUETOOTH™, ZigBee and/or radio frequency identification (RFID).

The embodiments shown and described above are only exemplarys. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts, order of method steps, all within the principles of the present disclosure up to, and including, the full extent established by the broad general meaning of the terms used in the claims.

What is claimed is:

1. A method for verifying a test strip comprising:
sensing a presence of a test strip in a biosensor monitor;
receiving a signal at one or more verification components of the biosensor monitor from one or more verification portions of the test strip;
verifying the identity of the test strip.

2. The method of claim 1, wherein the verification portions of the test strip comprise conductive pads and the method further comprising applying a plurality of different electrical potentials to the conductive pads of the test strip.

3. The method of claim 2, wherein applying the plurality of different electrical potentials comprises applying different combinations of the plurality of different electrical potentials to the one or more verification portions of the test strip.

4. The method of claim 2, wherein the one or more verification portions comprise a plurality of verification portions and applying the plurality of different electric potentials comprises applying different combinations of the plurality of different electrical potentials to the plurality of verification portions of the test strip.

5. The method of claim 1, wherein light is emitted from the one or more verification component of the biosensor and light reflected off of the one or more verification portions of the test strip is detected, wherein at least a portion of the one or more verification portions comprise a reflective pad.

6. The method of claim 1, wherein the one or more verification component comprises one or more bar code reader and the one or more verification portions of the test strip comprises one or more bar codes.

7. The method of claim 1, wherein the one or more verification portion comprises a plurality of holes on the test strip and the step of receiving the signal comprises emitting light from the biosensor monitor towards the test strip and sensing light passing through the plurality of holes in the test strip.

8. The method of claim 1, wherein the one or more verification portion comprises a colored pattern and the step of receiving the signal comprises detecting, at the biosensor monitor, the colored pattern on the test strip.

9. The method of claim 1, wherein the one or more verification portion comprises a signal transmitter on the test strip and the step of receiving the signal comprises receiving, at a signal receiver of the biosensor monitor, a signal transmitted by the signal transmitter on the test strip.

10. The method of claim 1, wherein the step of receiving the signal comprises repeating receiving of a signal at the one or more verification component over a period of time.

11. A test strip comprising:
a strip of material for receiving a biological material to be tested;
a verification portion configured to interact with a verification component of a biosensor monitor, wherein the verification portion provides the identity of the test strip.

12. The test strip of claim 11, wherein the verification portion includes a plurality of differently positioned electronic pads, a position of the electronic pad being configured to interact with the verification component to provide an identity of the test strip to the biosensor monitor.

13. The test strip of claim 11, wherein the verification portion comprises a plurality of reflective pads being configured to interact with the verification component to provide an identity of the test strip to the biosensor monitor.

14. The test strip of claim 11, wherein the verification portion comprises a bar code being configured to interact with the verification component to provide an identity of the test strip to the biosensor monitor.

15. The test strip of claim 11, wherein the verification portion forms a plurality of through holes located at different positions along a length of the test strip being configured to interact with the verification component to provide an identity of the test strip to the biosensor monitor.

16. The test strip of claim 11, wherein the verification portion comprises a colored pattern being configured to interact with the verification component to provide an identity of the test strip to the biosensor monitor.

17. The test strip of claim 16, wherein the colored pattern comprises differently colored blocks being configured to interact with the verification component to provide an identity of the test strip to the biosensor monitor.

18. The test strip of claim 17, wherein the differently colored blocks further comprise different sized and shaped blocks.

19. The test strip of claim 11, wherein the verification portion comprises at least one signal transmitter being configured to interact with the verification component to provide an identity of the test strip to the biosensor monitor.

20. The test strip of claim 11, wherein the strip has first side and second side opposite to the first side and the verification portion is located on both the first side and the second side.

21. A biosensor monitor for verifying a test strip comprising:
a test strip receiving portion configured to receive a test strip;
at least one test strip verification component located within the monitor to interact with at least one verification portion on the test strip, wherein the at least one test strip verification component is configured to receive data from the at least one verification portion on the test strip;
a processor configured to verify an identity of the test strip based on the data received from the at least one verification portion on the test strip.

22. The biosensor of claim 21, wherein the test strip verification components comprise:
a plurality of pins configured to contact the verification portions of the test strip,
a power source configured to apply, via the plurality of pins, different electrical potentials to the verification portion,
a processor configured to compare the electrical potentials with predetermined values, and output the results of the comparison to be displayed on a display.

23. The biosensor of claim 22, wherein the power source for applying different electrical potentials to different combinations of the conductive pads.

24. The biosensor of claim 23, wherein the power source applies different electrical potentials.

25. The biosensor of claim 21, wherein the at least one verification portion comprises at least a bar code and the at least one test strip verification component comprises at least a bar code reader.

26. The biosensor of claim 21, wherein the at least one verification portion comprises a plurality of holes located at different positions along the length of the test strip, and the at least one test strip verification component comprises a light source capable of providing light at one side of the test strip and a light sensor adjacent a second side of the test strip for detecting the light passing through the holes.

27. The biosensor of claim 21, wherein the at least one verification portion comprises at least a colored pattern and the at least one test strip verification component comprises at least a color detector.

28. The biosensor of claim 21, wherein the at least one verification portion comprises at least a signal transmitter and the at least one test strip verification component comprises at least a signal receiver.

29. The biosensor of claim 21, wherein the at least one verification component interacts with the at least one verification portions of the test strip to allow the biosensor monitor to verify the test strip at a plurality of distinct times during the insertion of the test strip into the biosensor monitor.
